(19) United States
(12) Patent Application Publication
(10) Pub. No.: US 2026/0109640 A1
(43) Pub. Date: Apr. 23, 2026

(54) WINDOW MANUFACTURING DEVICE AND WINDOW MANUFACTURING METHOD USING THE SAME

(71) Applicant: Samsung Display Co., LTD., Yongin-si (KR)

(72) Inventors: JUNHEE BAE, Yongin-si (KR); BEOMSOO KIM, Yongin-si (KR); HYUNCHUL KIM, Yongin-si (KR); BYOUNGYUL SHIM, Yongin-si (KR); SEUNGJUN LEE, Yongin-si (KR); JAEBOK LEE, Yongin-si (KR); JAE HOON JEONG, Yongin-si (KR); KANG DUK CHOI, Yongin-si (KR); SEUNGPYO HONG, Yongin-si (KR)

(21) Appl. No.: 19/350,027

(22) Filed: Oct. 5, 2025

(30) Foreign Application Priority Data
Oct. 18, 2024 (KR) 10-2024-0143010

(51) Int. Cl. C03C 15/00

(52) U.S. Cl. CPC C03C 15/00; C03C 2218/34

(57) ABSTRACT

A window manufacturing device includes a fixing jig including a seating surface on which preliminary glass is disposed, and a masking jig including a first sub-mask and a second sub-mask which are spaced apart from each other. Each of the first sub-mask and the second sub-mask includes a flat jig part having a flat surface facing the seating surface, and a slope jig part having an inclined surface which extends from the flat surface and has a distance from the seating surface in a thickness direction, where the distance gradually increases in a direction away from the flat surface.

This application claims priority to Korean Patent Application No. 10-2024-0143010, filed on Oct. 18, 2024, and all the benefits accruing therefrom under 35 U.S.C. § 119, the content of which in its entirety is herein incorporated by reference.

### BACKGROUND

### (1) Field

The present disclosure herein relates to a window manufacturing device and a window manufacturing method, and more particularly, to a window manufacturing device for manufacturing a glass window including a partially slimmed area, and a window manufacturing method using the window manufacturing device.

### (2) Brief Description of the Related Art

Various types of electronic devices are used to provide image information, and recently, electronic devices including flexible display panels capable of being folded or bent are developed. Unlike rigid electronic devices, flexible electronic devices may be variously changed in shape, for example, being folded, rolled, or bent, and thus may be portable regardless of sizes of screens on which images are displayed.

Such flexible electronic devices typically includes windows for protecting display panels while not disrupting folding or bending operations. Accordingly, it may be desired to develop methods and devices for manufacturing windows having good folding characteristics and also having high surface features, which do not affect display quality.

### SUMMARY

The present disclosure provides a method and device for manufacturing a window having excellent surface characteristics and durability.

The present disclosure also provides a method and device capable of manufacturing a window in which a slimming area of the window is easily controlled in shape and has a gentle inclined surface having no angular portion.

An embodiment of the invention provides a window manufacturing device including a fixing jig including a seating surface on which preliminary glass is disposed, and a masking jig disposed on the fixing jig and including a first sub-mask and a second sub-mask which are spaced apart from each other in a first direction. In such an embodiment, each of the first sub-mask and the second sub-mask includes a flat jig part having a flat surface facing the seating surface, and a slope jig part having an inclined surface which extends from the flat surface and has a distance from the seating surface in a thickness direction, where the distance gradually increases in a direction away from the flat surface.

In an embodiment, the inclined surface of the slope jig part may be an inclined flat surface without a discontinuity, or an inclined curved surface having a shape convex toward the fixing jig.

In an embodiment, the preliminary glass may include a preliminary folding portion disposed below the slope jig part, and a preliminary non-folding portion disposed below the flat jig part, and the preliminary folding portion may be processed to include a flat area, and a first slope area and a second slope area which are arranged to be spaced apart from each other in the first direction with the flat area disposed between the first and second slope areas. In such an embodiment, a width of the slope jig part in the first direction in each of the first sub-mask and the second sub-mask may correspond to a width of each of the first slope area and the second slope area in the first direction in a folding portion provided by slimming the preliminary glass.

In an embodiment, the folding portion may include a flat area disposed between the first slope area and the second slope area, and a separation distance between the first sub-mask and the second sub-mask in the first direction may correspond to a width of the flat area in the first direction.

In an embodiment, a difference in thickness in a second direction between one end of the slope jig part, which is connected to the flat jig part, and an opposing end of the slope jig part, which is spaced apart from the flat jig part, may be about 0.7 millimeter (mm) or less, and the second direction may be perpendicular to the first direction.

In an embodiment, the preliminary non-folding portion below the flat jig part may be processed into a non-folding portion, and a difference in thickness in a second direction between one end of the slope jig part, which is connected to the flat jig part, and an opposing end of the slope jig part, which is spaced apart from the flat jig part, may be about 10 times to about 30 times a difference in thickness in the second direction between the non-folding portion and the flat area. In such an embodiment, the second direction may be perpendicular to the first direction.

In an embodiment, the masking jig and the fixing jig may each independently include polytetrafluoroethylene or polyetheretherketone.

In an embodiment, each of the masking jig and the fixing jig may include a base portion including an anti-hydrofluoric acid material, and a magnet disposed in the base portion, and the masking jig and the fixing jig may be fixed to be adjacent to each other by the magnet with the preliminary glass disposed between the masking jig and the fixing jig.

In an embodiment, the window manufacturing device may further include an etchant supply part which stores an etchant, in which the fixing jig and the masking jig are immersed.

In an embodiment of the invention, a window manufacturing method is a window manufacturing method using a window manufacturing device including a fixing jig, and a masking jig facing the fixing jig and including a first sub-mask and a second sub-mask between which a separation area is disposed and each of which includes a flat surface and an inclined surface having a distance from the fixing jig in a thickness direction, where the distance gradually increases in a direction away from the flat surface. In such an embodiment, the window manufacturing method includes disposing preliminary glass on the fixing jig, moving the masking jig to fix the preliminary glass between the fixing jig and the masking jig, providing an etchant to the preliminary glass exposed in the separation area and below the inclined surface, and etching the preliminary glass to form a glass window including a recessed portion defined by a flat area corresponding to the separation area and a slope area corresponding to the inclined surface.

In an embodiment, the etchant may include a hydrofluoric acid solution, and each of the fixing jig and the masking jig may include an anti-hydrofluoric acid material.

In an embodiment, the inclined surface of the masking jig may be an inclined flat surface without a discontinuity, or an inclined curved surface having a shape convex toward the fixing jig, and, in the forming of the glass window, one exposed surface of the slope area may be formed to have a shape corresponding to the inclined surface.

In an embodiment, the preliminary glass may include a preliminary folding portion, and a first preliminary non-folding portion and a second preliminary non-folding portion which are spaced apart from each other in a first direction with the preliminary folding portion disposed between the first and second preliminary non-folding portions. The fixing of the preliminary glass may include totally covering a top surface and a bottom surface of each of the first preliminary non-folding portion and the second preliminary non-folding portion by the fixing jig and the masking jig, and exposing a partial area of the preliminary folding portion to fix the preliminary glass in a way such that a distance between the inclined surface and the preliminary folding portion gradually increases in a direction from the flat surface to the separation area.

In an embodiment, in the providing the etchant to the preliminary glass, an amount of the etchant provided to the preliminary glass may gradually decrease in a direction from the separation area to the flat surface.

In an embodiment, the window manufacturing method may further include, before the disposing the preliminary glass, patterning an etch stop film, in which an open area is defined, on the preliminary glass.

In an embodiment, the open area may define a preliminary folding portion in the preliminary glass, and, in the disposing the preliminary glass, exposed ends of the etch stop film, which define the open area, may be covered by the first sub-mask and the second sub-mask, respectively.

In an embodiment, the window manufacturing method may further include, before the disposing the preliminary glass, forming an oxide deposit pattern on the preliminary glass, and patterning an etch stop film, in which an open area is defined, on the preliminary glass to cover the oxide deposit pattern while exposing one side surface of the oxide deposit pattern.

In an embodiment, the oxide deposit pattern may include an indium oxide.

In an embodiment, in the providing the etchant, the etchant may be provided to the oxide deposit pattern.

In an embodiment, the preliminary glass may include a preliminary folding portion, and a first preliminary non-folding portion and a second preliminary non-folding portion which are spaced apart from each other in a first direction with the preliminary folding portion disposed between the first and second preliminary non-folding portions. In such an embodiment, in the forming the oxide deposit pattern, the oxide deposit pattern may be formed on each of the first preliminary non-folding portion and the second preliminary non-folding portion, and the oxide deposit pattern may have a thickness of about 10 micrometers (μm) or less and have a width in a range of about 1000 μm to about 2000 μm in the first direction.

### BRIEF DESCRIPTION OF THE DRAWINGS

The above and other features of embodiments of the invention will become more apparent by describing in further detail embodiments thereof with reference to the accompanying drawings, in which:

FIG. 1A is a perspective view illustrating a spread state of an electronic device according to an embodiment;

FIG. 1B is a perspective view illustrating an inner-folding operation of the electronic device according to an embodiment illustrated in FIG. 1A;

FIG. 1C is a perspective view illustrating an outer-folding operation of the electronic device according to an embodiment illustrated in FIG. 1A;

FIG. 2A is a perspective view illustrating a spread state of an electronic device according to an embodiment;

FIG. 2B is a perspective view illustrating an inner-folding operation of the electronic device according to an embodiment illustrated in FIG. 2A;

FIG. 2C is a perspective view illustrating an outer-folding operation of the electronic device according to an embodiment illustrated in FIG. 2A;

FIG. 3A is a perspective view of an electronic device according to an embodiment;

FIGS. 3B and 3C are each a perspective view of a multi-folded state of the electronic device illustrated in FIG. 3A;

FIG. 4 is an exploded perspective view of an electronic device according to an embodiment;

FIG. 5 is a cross-sectional view of an electronic device according to an embodiment;

FIG. 6 is a cross-sectional view of a window according to an embodiment;

FIG. 7 is a perspective view of a window manufacturing device according to an embodiment;

FIG. 8 is a cross-sectional view of a window manufacturing device according to an embodiment;

FIG. 9A is a cross-sectional view of a portion of a window manufacturing device according to an embodiment;

FIG. 9B is a schematic view illustrating a masking jig and a shape of a processed window according to an embodiment;

FIG. 10 is a flowchart of a window manufacturing method according to an embodiment;

FIGS. 11A to 11C are each a view illustrating a process of a window manufacturing method according to an embodiment;

FIGS. 12A to 12C are each a view illustrating a process of a window manufacturing method according to an embodiment;

FIG. 12D is a cross-sectional view of a window manufactured by a window manufacturing method according to an embodiment;

FIGS. 13A to 13D are each a view illustrating a process of a window manufacturing method according to an embodiment; and

FIG. 13E is a cross-sectional view of a window manufactured by a window manufacturing method according to an embodiment.

### DETAILED DESCRIPTION

The invention now will be described more fully hereinafter with reference to the accompanying drawings, in which various embodiments are shown. This invention, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

In this specification, it will be understood that when an element (or a region, a layer, a portion, or the like) is referred to as being ““connected to” or “coupled to” another element, it may be directly connected to, or coupled to the other element, or other elements may be disposed therebetween.

Like reference numerals or symbols refer to like elements throughout. In the drawings, the thickness, ratio, and size of the elements are exaggerated for effectively describing the technical contents.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

In this specification, “a region/portion corresponding to another region/portion” means that the regions/portions “overlap each other”, and is not limited to the meaning that the regions/portions having the same surface area and/or the same shape. In addition, in this specification, “a region/portion overlapping another region/portion” means that the region/portion overlaps the other region/portion when viewed on a plane, and includes a case in which the region/portion at least partially overlap the other region/portion on a plane.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an electronic device according to an embodiment, a window manufacturing device according to an embodiment, and a window manufacturing method according to an embodiment will be described in detail with reference to the accompanying drawings.

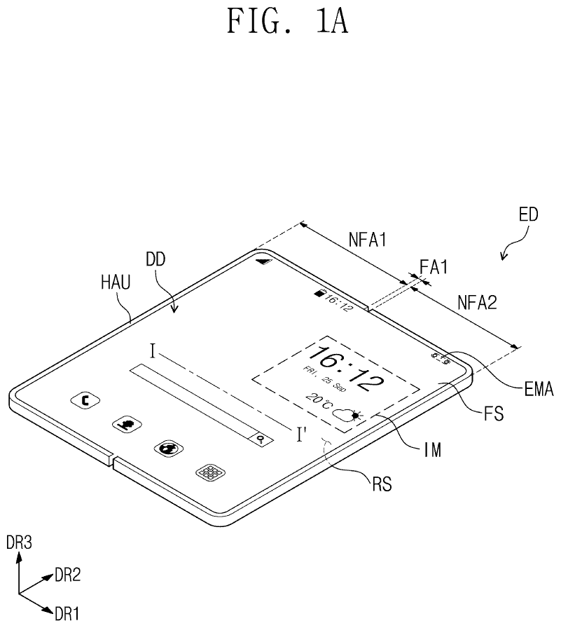

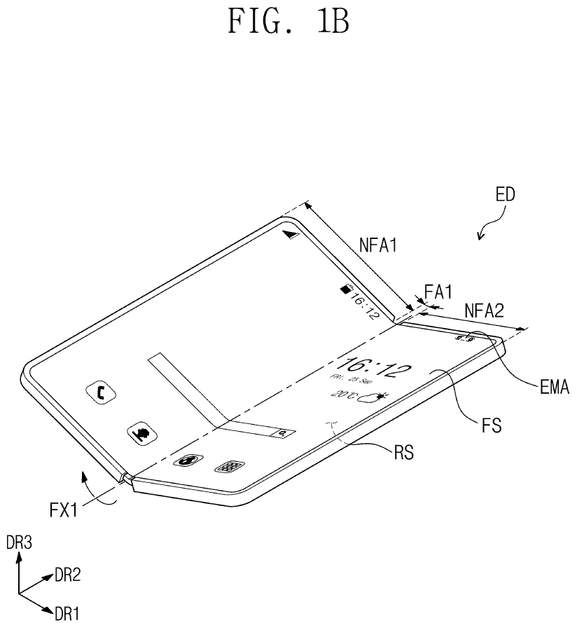

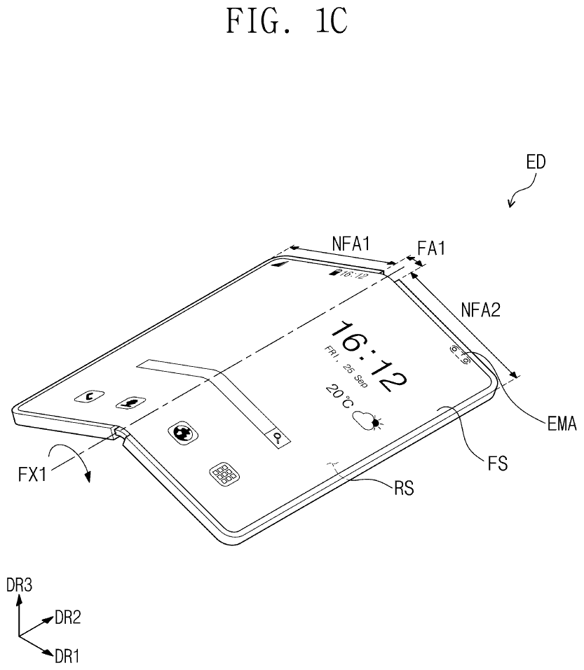

FIGS. 1A to 5 each illustrate an electronic device according to an embodiment, and the electronic device according to an embodiment illustrated in FIGS. 1A to 5 includes a glass window manufactured by a window manufacturing device according to an embodiment and a window manufacturing method according to an embodiment, which will be described later. The glass window manufactured by the window manufacturing device according to an embodiment and the window manufacturing method according to an embodiment may be referred to as a window.

FIG. 1A is a perspective view illustrating a spread state (or unfolded state) of an electronic device according to an embodiment. FIG. 1B is a perspective view illustrating an inner-folding operation of the electronic device illustrated in FIG. 1A. FIG. 1C is a perspective view illustrating an outer-folding operation of the electronic device illustrated in FIG. 1A.

An electronic device ED according to an embodiment may be a device that is activated in response to an electrical signal. In an embodiment, for example, the electronic device ED may be a mobile phone, a tablet computer, a vehicle navigation unit, a game console, or a wearable device, but an embodiment is not limited thereto. In the present disclosure, FIG. 1A and the like illustrate embodiments where the electronic device ED is a mobile phone as an example.

Referring to FIGS. 1A to 1C, the electronic device ED according to an embodiment may include a first display surface FS on a plane defined by a first directional axis DR1 and a second directional axis DR2 crossing the first directional axis DR1. The electronic device ED may provide an image IM for a user through the first display surface FS. The electronic device ED according to an embodiment may display the image IM in a third directional axis DR3 direction on the first display surface FS parallel to each of the first directional axis DR1 and the second directional axis DR2. In the present disclosure, a front surface (or top surface) and a rear surface (or bottom surface) of each component are defined on the basis of a direction in which the image IM is displayed. The front surface and the rear surface may oppose each other in the direction of the third directional axis DR3, and a normal direction to each of the front surface and the rear surface may be parallel to the third directional axis DR3. Here, the direction of the third directional axis DR3 may be a thickness direction of the electronic device ED.

The electronic device ED according to an embodiment may include the first display surface FS and a second display surface RS. The first display surface FS may include an electronic module area EMA. The second display surface RS may be defined as a surface opposing at least a portion of the first display surface FS. That is, the second display surface RS may be defined as a portion of a rear surface of the electronic device ED.

The electronic device ED according to an embodiment may detect an external input applied from the outside. The external input may include various types of inputs provided from the outside of the electronic device ED. In an embodiment, for example, the external input may include not only a touch by part of the body, such as a user's hand, but also an external input (e.g., hovering) applied by approaching the electronic device ED or being adjacent thereto by a certain distance. In addition, the external input may include various types such as force, pressure, temperature, and light.

FIG. 1 and the following drawings illustrate the first directional axis DR1 to the third directional axis DR3, and directions indicated by the first to third directional axes DR1, DR2 and DR3 used herein are relative concepts and may be changed to other directions. In addition, the directions indicated by the first to third directional axes DR1, DR2 and DR3 may be described as first to third directions, respectively, and like reference numbers or symbols may be used.

The first display surface FS of the electronic device ED may include an active area that is an area activated in response to an electrical signal. The electronic device ED according to an embodiment may display the image IM through the first display surface FS. In addition, the first display surface FS may detect various types of external inputs.

The electronic device ED may include a folding area FA1 and non-folding areas NFA1 and NFA2. In an embodiment, the non-folding areas NFA1 and NFA2 may be disposed adjacent to the folding area FA1 with the folding area FA1 disposed between the non-folding areas NFA1 and NFA2. The electronic device ED according to an embodiment may include a first non-folding area NFA1 and a second non-folding area NFA2, which are arranged to be spaced apart from each other in a first directional axis DR1 direction with the folding area FA1 disposed between the non-folding areas NFA1 and NFA2. In an embodiment, for example, the first non-folding area NFA1 may be disposed at (or connected to) one side of the folding area FA1 in the first direction DR1, and the second non-folding area NFA2 may be disposed at (or connected to) the other side of the folding area FA1 in the first direction DR1.

FIGS. 1A to 1C illustrate an embodiment of the electronic device ED including a single folding area FA1. However, an embodiment is not limited thereto, and a plurality of folding areas may be defined in the electronic device ED. In an embodiment, for example, the electronic device according to an embodiment may include two or more folding areas, and also three or more non-folding areas disposed with each of the folding areas disposed between the non-folding areas.

Referring to FIG. 1B, the electronic device ED according to an embodiment may be folded around a first folding axis FX1. The first folding axis FX1 is an imaginary axis extending in the second directional axis DR2 direction, and the first folding axis FX1 may be parallel to a long-side direction of the electronic device ED. The first folding axis FX1 may extend along the second directional axis DR2 on the first display surface FS.

The electronic device ED may be folded around the first folding axis FX1 to be changed into an inner-folded state in which one area, which overlaps the first non-folding area NFA1, of the first display surface FS and the other area, which overlaps the second non-folding area NFA2, of the first display surface FS face each other.

In a state in which the electronic device ED according to an embodiment is inner-folded, the second display surface RS may be visible to a user. The second display surface RS may further include an electronic module area in which an electronic module including various components is disposed, and is not limited to any one embodiment.

Referring to FIG. 1C, the electronic device ED according to an embodiment may be folded around the first folding axis FX1 to be changed into an outer-folded state in which one area, which overlaps the first non-folding area NFA1, of the second display surface RS and the other area, which overlaps the second non-folding area NFA2, of the second display surface RS face each other.

However, an embodiment is not limited thereto. The electronic device ED may be folded around a plurality of folding axes so that respective one portions of the first display surface FS and the second display surface RS face each other, and the number of the folding axes and the number of the resulting non-folding areas are not particularly limited.

Various electronic modules may be disposed in the electronic module area EMA. In an embodiment, for example, the electronic modules may include at least one selected from a camera, a speaker, a light detecting sensor, or a heat detecting sensor. The electronic module area EMA may detect an external subject received through the first or second display surface FS or RS, or provide the outside with a sound signal such as voice, through the first or second display surface FS or RS. The electronic module may include a plurality of components, and is not limited to any one embodiment.

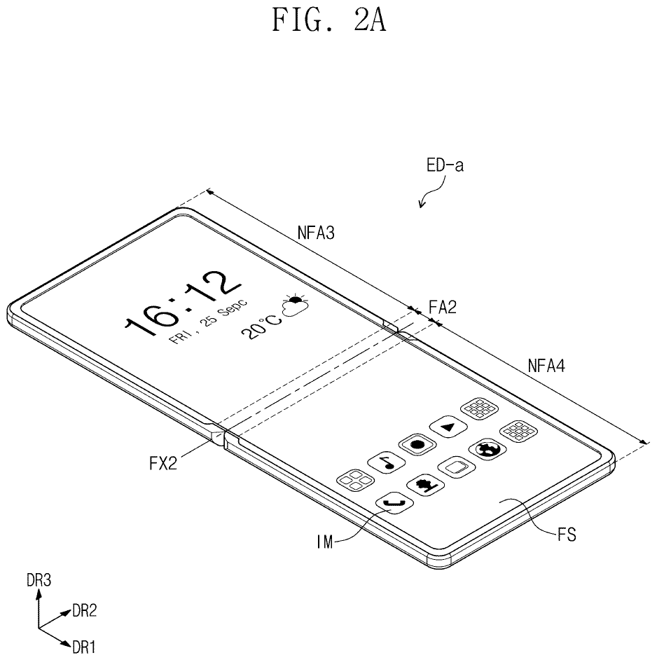

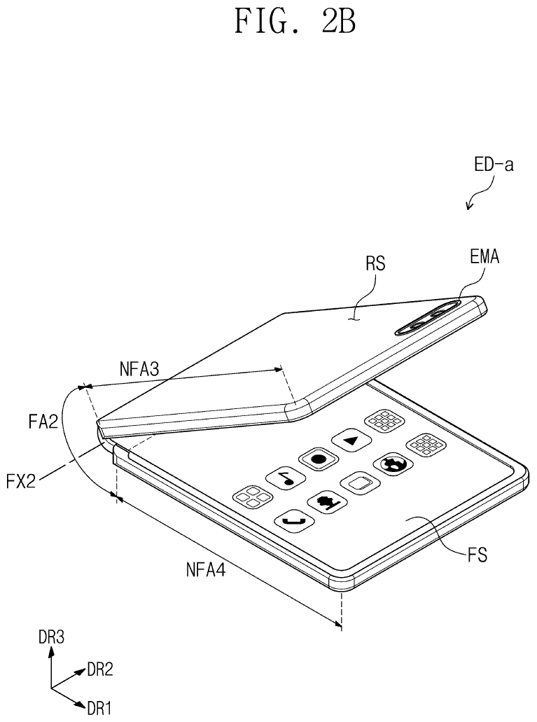

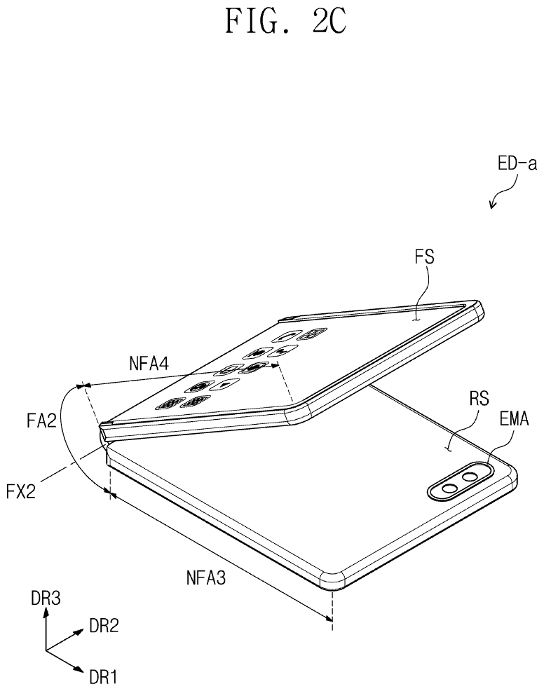

FIG. 2A is a perspective view illustrating a spread state of an electronic device according to an embodiment. FIG. 2B is a perspective view illustrating an inner-folding operation of the electronic device illustrated in FIG. 2A. FIG. 2C is a perspective view illustrating an outer-folding operation of the electronic device illustrated in FIG. 2A.

An electronic device ED-a according to an embodiment may be folded around a second folding axis FX2 extending in one direction parallel to the second directional axis DR2. FIG. 2B illustrates an embodiment in which an extension direction of the second directional axis DR2 is parallel to an extension direction of a short side of the electronic device ED-a. However, an embodiment is not limited thereto.

The electronic device ED-a according to an embodiment may include at least one folding area FA2 and non-folding areas NFA3 and NFA4, each of which is adjacent to the folding area FA2. The non-folding areas NFA3 and NFA4 may be arranged to be spaced apart from each other with the folding area FA2 disposed between the non-folding areas NFA3 and NFA4.

The folding area FA2 has a certain curvature and a certain radius of curvature. In an embodiment, a first non-folding area NFA3 and a second non-folding area NFA4 may face each other, and the electronic device ED-a may be inner-folded such that a display surface FS is not exposed to the outside. Referring to FIG. 2C, the electronic device ED-a according to an embodiment may be outer-folded such that a first display surface FS is exposed to the outside.

The electronic device ED-a according to an embodiment may include a second display surface RS, and the second display surface RS may be defined as a surface opposing at least a portion of the first display surface FS. The second display surface RS may include an electronic module area EMA in which an electronic module including various components is disposed. In addition, an image or a video may be displayed on at least a portion of the second display surface RS.

In an embodiment, in a state in which the electronic device ED-a is not folded, the first display surface FS may be visible to a user, and in the inner-folded state, the second display surface RS may be visible to a user.

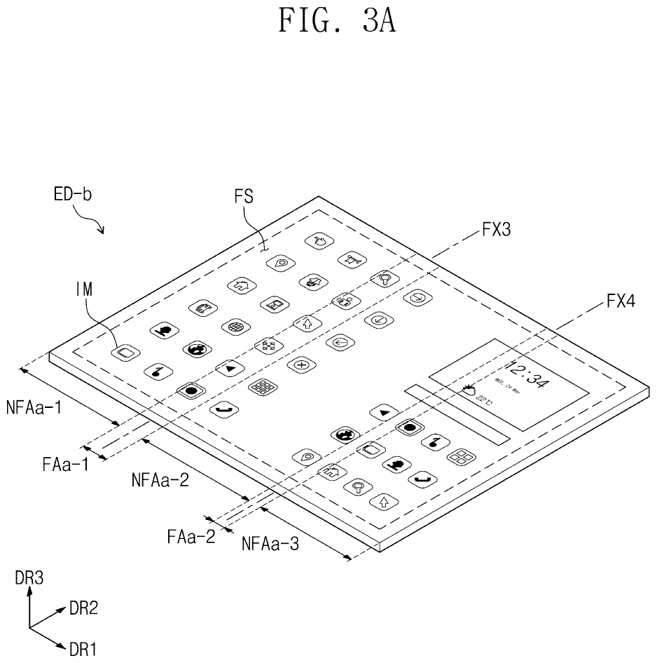

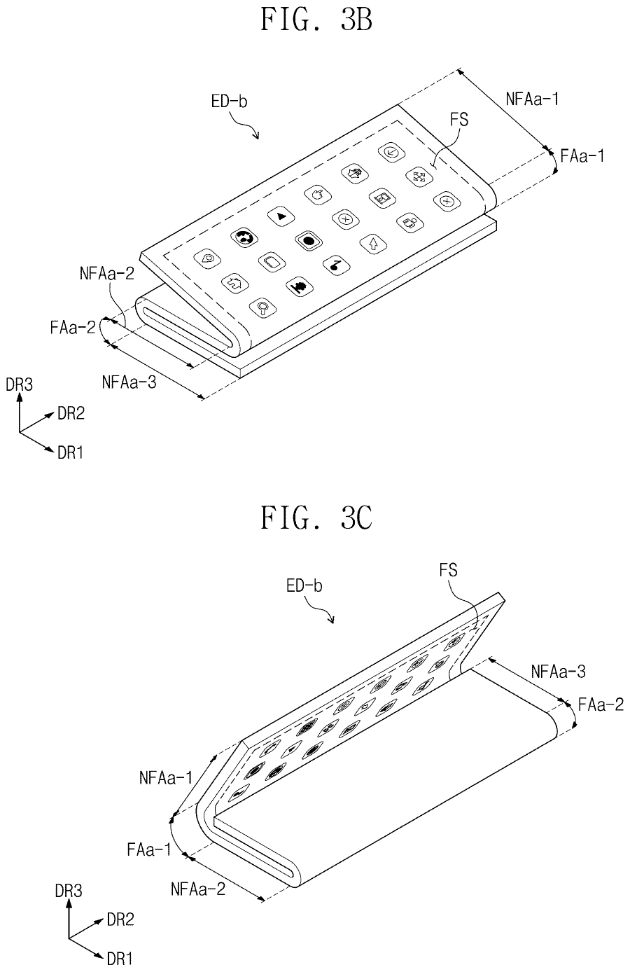

FIG. 3A is a perspective view illustrating a spread state of an electronic device ED-b according to an embodiment. FIGS. 3B and 3C are each a perspective view of a multi-folded state of the electronic device ED-b illustrated in FIG. 3A.

Referring to FIGS. 3A to 3C, the electronic device ED-b according to an embodiment may be a multi-foldable device including a plurality of folding areas. The electronic device ED-b may include a plurality of folding areas FAa-1 and FAa-2 and a plurality of non-folding areas NFAa-1, NFAa-2 and NFAa-3. The electronic device ED-b according to an embodiment may include a first folding area FAa-1, a second folding area FAa-2, a first non-folding area NFAa-1, a second non-folding area NFAa-2, and a third non-folding area NFAa-3. In the first direction DR1, the first folding area FAa-1 is disposed between the first non-folding area NFAa-1 and the second non-folding area NFAa-2, and the second folding area FAa-2 is disposed between the second non-folding area NFAa-2 and the third non-folding area NFAa-3. FIGS. 3A to 3C illustrate an embodiment where the two folding areas FAa-1 and FAa-2 and the three non-folding areas NFAa-1, NFAa-2 and NFAa-3 are defined as an example, but the number of the folding areas FAa-1 and FAa-2 and the number of the non-folding areas NFAa-1, NFAa-2 and NFAa-3 are not limited thereto and may be increased.

Referring to FIGS. 3A and 3B, the first folding area FAa-1 may be folded around a third folding axis FX3 parallel to the second direction DR2. The first folding area FAa-1 may be outer-folded such that a rear surface of the second non-folding area NFAa-2 faces a rear surface of the first non-folding area NFAa-1, and a display surface of the first non-folding area NFAa-1 is exposed to the outside. The second folding area FAa-2 may be folded around a fourth folding axis FX4 parallel to the second direction DR2. The second folding area FAa-2 may be inner-folded such that a display surface of the second non-folding area NFAa-2 and a display surface of the third non-folding area NFAa-3 face each other.

Referring to FIGS. 3A and 3C, the second folding area FAa-2 may be folded around the fourth folding axis FX4 parallel to the second direction DR2. The second non-folding area NFAa-2 may be inner-folded such that the display surface of the second non-folding area NFAa-2 is disposed in the inside, and the display surface of the third non-folding area NFAa-3 faces the display surface of the second non-folding area NFAa-2. The first folding area FAa-1 may be folded around the third folding axis FX3 parallel to the second direction DR2. The inner-folding operation may be performed so that a rear surface of the third non-folding area NFAa-3 and the display surface of the first non-folding area NFAa-1 face each other.

However, the multi-folded state is not limited to the shapes illustrated in FIGS. 3B and 3C, and may have various folding shapes.

In an embodiment of the invention, the outer-folding operation and the inner-folding operation may be performed at the same time, and only one of the outer-folding operation and the inner-folding operation may be performed.

In an embodiment, the electronic device ED, ED-a or ED-b may be provided to repeat an operation from a spreading operation to an inner-folding or outer-folding operation, or vice versa, but an embodiment is not limited thereto. In an embodiment, the electronic devices ED, ED-a and ED-b may be provided to selectively perform one operation among the spreading operation, the inner-folding operation, and the outer-folding operation. In addition, in an embodiment in which a plurality of folding areas are included, a folding direction of at least one of the plurality of folding areas may be different from folding directions of the remaining folding areas. In an embodiment, for example, where two folding areas are included, two non-folding areas with one folding area disposed between the non-folding areas may be folded in the inner-folding operation, and two non-folding areas with the other folding area disposed between the non-folding areas may be folded in the outer-folding operation.

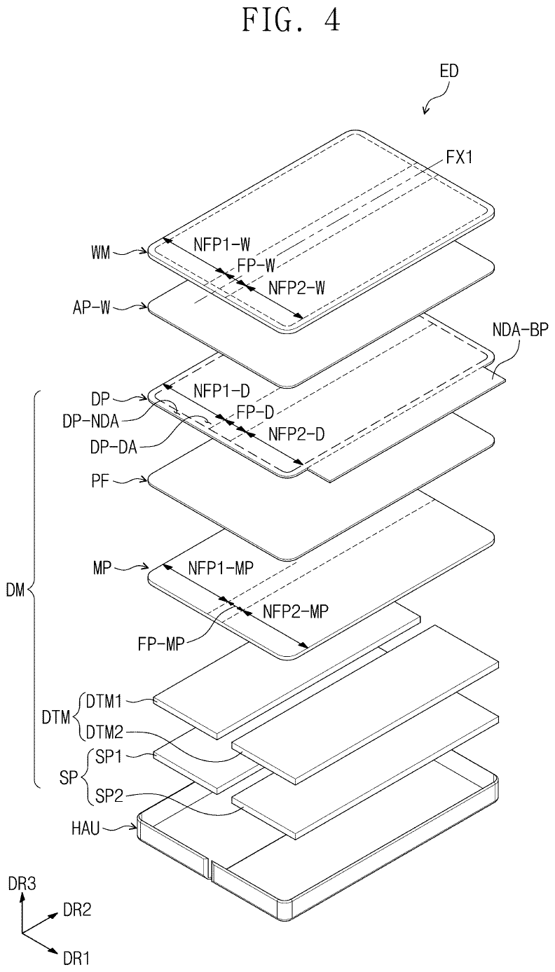

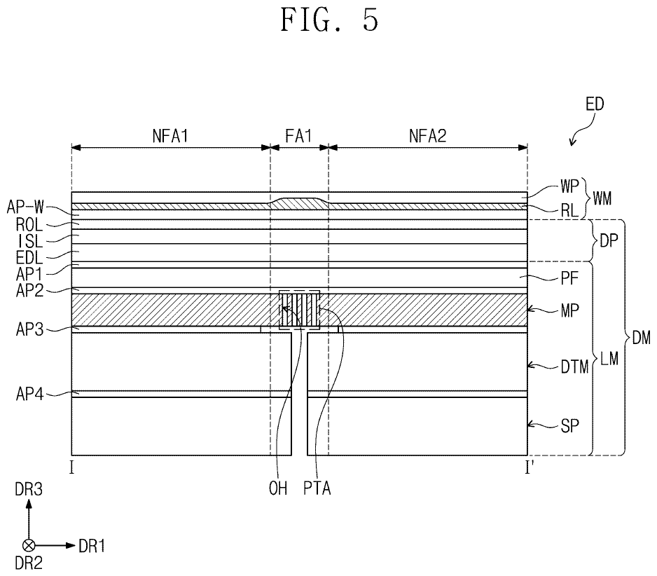

FIG. 4 is an exploded perspective view of an electronic device according to an embodiment. FIG. 5 is a cross-sectional view illustrating a portion of an electronic device according to an embodiment. FIG. 5 is a cross-sectional view illustrating a portion corresponding to a cross-section taken along line I-I′ in FIG. 1A.

FIGS. 4 and 5 illustrate an embodiment in which a folding axis FX1 is parallel to a long side of an electronic device ED, like the electronic device ED illustrated in FIG. 1A and the like. However, an embodiment is not limited thereto, and contents described below with reference to the drawings may also apply to a case in which a folding axis FX2 is parallel to a short side of an electronic device as illustrated in FIG. 2A and the like, or to an electronic device multi-folded as illustrated in FIG. 3A and the like.

The electronic device ED according to an embodiment may include a display module DM, a window module WM, and a housing HAU which accommodates the display module DM and the window module WM.

The display module DM may include a display panel DP and a lower module LM disposed below the display panel DP. The lower module LM may include a support plate MP. In an embodiment, the lower module LM of the display module DM may further include at least one selected from a protective layer PF, a support member SP, adhesive layers AP1, AP2, AP3 and AP4, or a digitizer module DTM in addition to the support plate MP.

The display panel DP may display an image in response to an electrical signal, and transmit/receive information about an external input. The display panel DP may include a display area DP-DA and a non-display area DP-NDA. The display area DP-DA may be defined as an area from which an image provided by the display panel DP is output.

The non-display area DP-NDA is adjacent to the display area DP-DA. In an embodiment, for example, the non-display area DP-NDA may surround the display area DP-DA as shown in FIG. 4. However, this is illustrated as an example, and the non-display area DP-NDA may be defined to have various shapes and is not limited to any one embodiment. In addition, the display panel DP may include a non-display bending portion NDA-BP disposed at at least one side of the non-display area DP-NDA. The non-display bending portion NDA-BP may be bent to a lower side of the display module DM and arranged to at least partially overlap the display panel DP. A circuit layer, a connection line, a circuit board, or the like, for displaying an image or transmitting/receiving information may be mounted on or attached to the non-display bending portion NDA-BP.

In an embodiment, the display panel DP includes a display layer EDL. The display layer EDL may be a component that substantially generates an image. The image generated by the display layer EDL may be externally visible to a user through the first display surface FS (see FIG. 1A). The display layer EDL may be an emissive display layer but is not particularly limited. In an embodiment, for example, the display layer EDL may be an organic light emitting display layer or an inorganic light emitting display layer. The organic light emitting display layer may include a light emitting element in which a light emitting layer includes an organic light emitting material. The inorganic light emitting display layer may include a light emitting element in which a light emitting layer includes a material such as a quantum dot and a quantum rod.

The display panel DP may further include a sensor layer ISL. The sensor layer ISL may be directly disposed on the display layer EDL. The sensor layer ISL may include a plurality of sensing electrodes. The sensor layer ISL may sense an external input using a self-capacitance method or a mutual capacitance method. The sensor layer ISL may sense an input by an active-type input device.

During manufacture of the display layer EDL, the sensor layer ISL may be directly disposed on the display layer EDL through a continuous process. However, an embodiment is not limited thereto, and the sensor layer ISL may be manufactured as a separate panel from the display layer EDL to be attached to the display layer EDL through an adhesive layer (not illustrated).

The display panel DP may further include an optical layer ROL. The optical layer ROL may function to reduce reflection of external light. In an embodiment, for example, the optical layer ROL may include a polarizing layer or a color filter layer. However, an embodiment is not limited thereto, and the optical layer ROL may include optical members for improving display quality of the display module DM.

In an embodiment, the optical layer ROL may be directly disposed on the sensor layer ISL. Alternatively, in another embodiment in which the sensor layer ISL is omitted from the display panel DP, the optical layer ROL may be directly disposed on the display layer EDL. However, an embodiment is not limited thereto, and the optical layer ROL may be disposed on the display layer EDL or the sensor layer ISL using a separate adhesive member.

The display panel DP may include a folding display portion FP-D and non-folding display portions NFP1-D and NFP2-D. The folding display portion FP-D may be a portion corresponding to the folding area FA1 (see FIG. 1A), and the non-folding display portions NFP1-D and NFP2-D may be portions corresponding to the non-folding areas NFA1 and NFA2 (see FIG. 1A). In the display panel DP, the folding display portion FP-D and the non-folding display portions NFP1-D and NFP2-D may be respectively referred to as a folding display portion and non-folding display portions of the display module DM.

The folding display portion FP-D may correspond to a portion folded or bent around the folding axis FX1 (see FIG. 1A). The display panel DP may include a first non-folding display portion NFP1-D and a second non-folding display portion NFP2-D, and the first non-folding display portion NFP1-D and the second non-folding display portion NFP2-D may be spaced apart from each other in the first direction DR1 with the folding display portion FP-D disposed between the first and second non-folding display portions NFP1-D and NFP2-D. The folding display portion FP-D may be a portion corresponding to a folding area FA1 of the electronic device ED, and the first non-folding display portion NFP1-D and the second non-folding display portion NFP2-D may be respectively portions corresponding to a first non-folding area NFA1 and a second non-folding area NFA2 of the electronic device ED.

In an embodiment, the support plate MP may be disposed below the display panel DP. The support plate MP may include a folding support portion FP-MP and non-folding support portions NFP1-MP and NFP2-MP. A first non-folding support portion NFP1-MP and a second non-folding support portion NFP2-MP of the support plate MP may be spaced apart from each other in the first direction DR1 with the folding support portion FP-MP between the first and second non-folding support portions NFP1-MP and NFP2-MP. The folding support portion FP-MP may be a portion corresponding to the folding area FA1 (see FIG. 1A), and the non-folding support portions NFP1-MP and NFP2-MP may be portions corresponding to the non-folding areas NFA1 and NFA2 (see FIG. 1A). The support plate MP may include a pattern portion PTA in which a plurality of openings OH are defined. The pattern portion PTA may be included in the folding support portion FP-MP. The pattern portion PTA may be arranged to correspond to the folding area FA1, thereby improving the folding or bending characteristics of the electronic device ED.

In the display module DM according to an embodiment, the protective layer PF of the lower module LM may be disposed between the display panel DP and the support plate MP. The protective layer PF may be disposed below the display panel DP and protect a rear surface of the display panel DP. The protective layer PF may overlap the entirety (or an entire lower surface) of the display panel DP. The protective layer PF may include a polymer material. In an embodiment, for example, the protective layer PF may be a polyimide film or a polyethylene terephthalate film. However, this is an example, and the material of the protective layer PF is not limited thereto.

In an embodiment, the lower module LM may include the support member SP. The support member SP may include support layers SP1 and SP2. The support layers SP1 and SP2 may include a first support layer SP1 and a second support layer SP2 that are spaced apart from each other in the first direction DR1. The first support layer SP1 and the second support layer SP2 may be separated from each other at a portion corresponding to the first folding axis FX1 (see FIG. 1A). The support layers SP1 and SP2 may be separated from each other in the folding area FA1 and provided as the first support layer SP1 and the second support layer SP2, thereby improving the folding or bending characteristics of the electronic device ED. Although not illustrated, the support layers SP1 and SP2 may further include components such as a cushion layer (not illustrated) and a lower support plate (not illustrated) which are stacked in a thickness direction.

The electronic device ED according to an embodiment may further include the digitizer module DTM disposed below the support plate MP. The digitizer module DTM according to an embodiment may include components such as a digitizer layer and a shielding layer. The digitizer module DTM may be included as a component of the lower module LM.

The digitizer module DTM may include a first digitizer module DTM1 and a second digitizer module DTM2 which are arranged to be spaced apart from each other at a portion overlapping the folding area FA1. The first digitizer module DTM1 may be arranged to correspond to the first non-folding area NFA1, and the second digitizer module DTM2 may be arranged to correspond to the second non-folding area NFA2.

That is, in an embodiment, the first digitizer module DTM1 and the second digitizer module DTM2 may be spaced apart from each other at a portion overlapping the folding display portion FP-D. The first digitizer module DTM1 may overlap the first non-folding display portion NFP1-D, and the second digitizer module DTM2 may overlap the second non-folding display portion NFP2-D.

In addition, the electronic device ED according to an embodiment may include at least one adhesive layer AP1, AP2, AP3 or AP4. In an embodiment, for example, a first adhesive layer AP1 may be disposed between the display panel DP and the protective layer PF, and a second adhesive layer AP2 may be disposed between the protective layer PF and the support plate MP. A third adhesive layer AP3 and a fourth adhesive layer AP4 may be disposed between the support plate MP and the support member SP. The at least one adhesive layer AP1, AP2, AP3 or AP4 may be an optically clear adhesive film or an optically clear adhesive resin layer. However, an embodiment is not limited thereto, and the at least one adhesive layer AP1, AP2, AP3 or AP4 may be an adhesive layer having a transmittance of about 80% or less.

Although FIGS. 4 and 5 illustrate an embodiment where the lower module LM includes all of the protective layer PF, the support plate MP, the support member SP, the adhesive layers AP1, AP2, AP3 and AP4, and the digitizer module DTM, an embodiment is not limited to the illustrated embodiment, and in the components of the lower module LM, only some of the foregoing components may be selected in light of mechanical properties, shapes, or operation characteristics required in the electronic device ED, or components other than the foregoing components of the lower module may be added.

The electronic device ED according to an embodiment includes the window module WM disposed on the display module DM. The window module WM may include a folding portion FP-W and non-folding portions NFP1-W and NFP2-W. A first non-folding portion NFP1-W and a second non-folding portion NFP2-W of the window module WM may be spaced apart from each other in the first direction DR1 with the folding portion FP-W disposed between the first and second non-folding portions NFP1-W and NFP2-W. The folding portion FP-W may be a portion corresponding to the folding area FA1 of the electronic device ED (see FIG. 1A), and the non-folding portions NFP1-W and NFP2-W may be portions corresponding to the non-folding areas NFA1 and NFA2 of the electronic device ED (see FIG. 1A). In addition, the folding portion FP-W may be a portion corresponding to the folding display portion FP-D, and the non-folding portions NFP1-W and NFP2-W may be portions corresponding to the non-folding display portions NFP1-D and NFP2-D.

The window module WM may cover an entire top surface of the display module DM. In an embodiment, the window module WM may be used as a cover window of the electronic device ED. In an embodiment, the window module WM may correspond to the uppermost member of the electronic device ED.

In an embodiment, the window module WM may include a window WP and a resin layer RL. The resin layer RL may be disposed on a top surface or a bottom surface of the window WP. The drawing herein illustrates an embodiment where the resin layer RL disposed on the bottom surface of the window WP, but an embodiment of the invention is not limited thereto. In an embodiment, for example, the resin layer RL may be disposed on the top surface of the window WP, or the resin layer RL may be arranged to cover the top surface and a side surface of the window WP.

In an embodiment, the resin layer RL may include an organic resin. Alternatively, the resin layer RL may include a composite resin including both an organic material and an inorganic material.

In an embodiment, the window WP may be a strengthened glass substrate. The window WP may be an ultra-thin strengthened glass substrate. The window WP may have flexibility which allows folding or bending to easily perform state changes.

In an embodiment, the window WP may include a slimming area having a smaller average thickness than other portions, and the slimming area may be arranged to correspond to the folding area FA1 of the electronic device. As an example, FIG. 5 illustrates an embodiment of the electronic device ED including a single folding area FA1, but in a case in which a plurality of folding areas are included, the window WP may include slimming areas corresponding to the folding areas, respectively. As the window WP includes the slimming area, the electronic device ED may exhibit excellent folding or bending characteristics.

The window WP according to an embodiment may be a glass window manufactured by a window manufacturing device according to an embodiment and a window manufacturing method according to an embodiment, which will be described later.

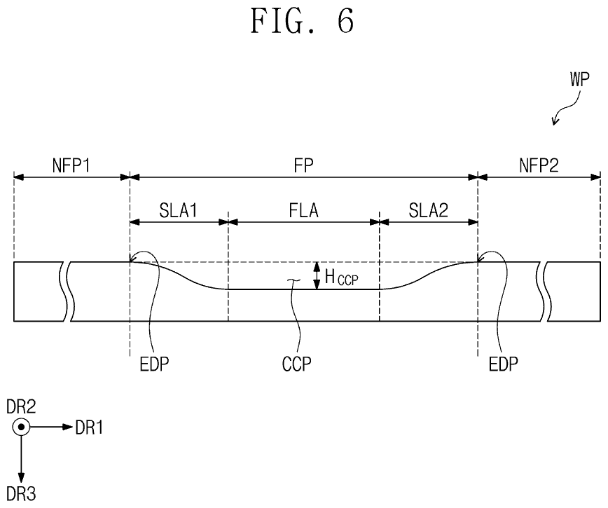

FIG. 6 is a cross-sectional view of a window according to an embodiment. A window WP according to an embodiment may include a folding portion FP, and a first non-folding portion NFP1 and a second non-folding portion NFP2 which are spaced apart from each other in the first direction DR1 with the folding portion FP disposed between the first and second non-folding portions NFP1 and NFP2.

The folding portion FP may include slope areas SLA1 and SLA2, which are portions adjacent to the non-folding portions NFP1 and NFP2 and having gradually decreasing thicknesses, and a flat area FLA disposed between the slope areas SLA1 and SLA2. The flat area FLA may be a portion having a relatively small thickness compared to the non-folding portions NFP1 and NFP2.

A first slope area SLA1 may be a portion disposed between the first non-folding portion NFP1 and the flat area FLA. The first slope area SLA1 may be a portion having a thickness which gradually decreases in a direction from the first non-folding portion NFP1 to the flat area FLA. A second slope area SLA2 may be a portion disposed between the second non-folding portion NFP2 and the flat area FLA. The second slope area SLA2 may be a portion having a thickness which gradually decreases in a direction from the second non-folding portion NFP2 to the flat area FLA.

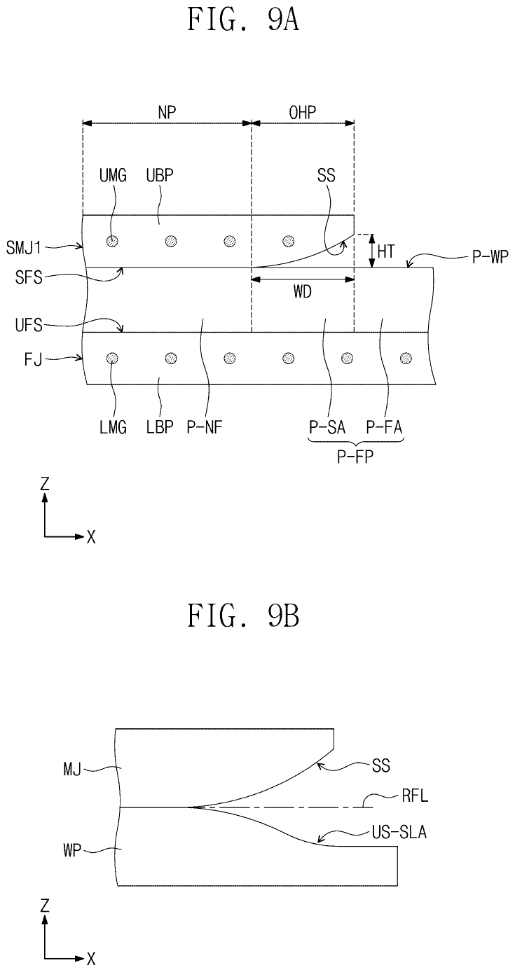

The slope areas SLA1 and SLA2 may be portions formed by a slope jig part OHP (see FIG. 9A) of a masking jig MJ in the window manufacturing device according to an embodiment, which will be described later. The slope jig part OHP (see FIG. 9A) may have an overhang structure in which a width gradually decreases in a direction from an upper portion to a lower portion. The window manufacturing device according to an embodiment will be described later in greater detail.

The folding portion FP may include a recessed portion CCP. The recessed portion CCP may be a concave portion recessed from at least one of a top surface or a bottom surface of the window. The recessed portion CCP may be a portion defined as the slope areas SLA1 and SLA2 and the flat area FLA. A depth HCCP of the recessed portion CCP corresponds to a difference in thickness in the third direction DR3 between each of the non-folding portions NFP1 and NFP2 and the flat area FLA. The depth HCCP of the recessed portion CCP may correspond to an etching depth of preliminary glass when etching the preliminary glass to manufacture a window in the window manufacturing method according to an embodiment using the window manufacturing method according to an embodiment, which will be described later.

The recessed portion CCP may have a shape extending in the second direction DR2. An extension direction of the recessed portion CCP may correspond to an extension direction of the folding axis FX1 (see FIG. 4). The folding portion FP in which the recessed portion CCP is defined corresponds to a portion having a relatively small thickness compared to the first non-folding portion NFP1 and the second non-folding portion NFP2 of the window. The folding portion FP may be referred to as the slimming area.

Referring to FIG. 5, in an embodiment, the window WP may be disposed in a way such that the recessed portion CCP has a shape recessed in a direction that is away from the top surface of the display panel DP. However, an embodiment is not limited thereto, and in another embodiment, the window WP may be disposed in a way such that the recessed portion CCP has a concave shape recessed toward the display panel DP.

Each of edge portions EDP which are boundaries between the slope areas SLA1 and SLA2 and the non-folding portions NFP1 and NFP2 of the folding portion FP may be a portion corresponding to a portion which is a boundary between the slope jig part OHP (see FIG. 9A) and a flat jig part NP (see FIG. 9A) in the window manufacturing device according to an embodiment to be described later. In addition, the edge portion EDP may be a portion which is a boundary of an open area defined in an etch stop film in the window manufacturing method according to an embodiment to be described later. In a case in which the window manufacturing method according to an embodiment to be described later further includes forming an oxide deposit pattern, the edge portion EDP may be processed as a boundary portion having a gently curved surface.

In the window WP according to an embodiment illustrated in FIG. 6, the recessed portion CCP is defined in only one surface (the top surface or the bottom surface) of the window. However, an embodiment is not limited thereto, and the recessed portion may be defined in each of the top surface and the bottom surface of the window WP according to an embodiment.

FIG. 6 illustrates an embodiment where one surface of each of the slope areas SLA1 and SLA2, which define the recessed portion CCP, has a curved surface, but an embodiment is not limited thereto. One surface of the recessed portion CCP defined in the window WP according to an embodiment may include a curved surface without a discontinuity (any stepped structure), or a flat diagonal (or inclined) surface without a discontinuity. The one surface of each of the slope areas SLA1 and SLA2, which define the recessed portion CCP, may include a curved surface without a discontinuity, or a flat diagonal surface without a discontinuity.

The one surface of each of the slope areas SLA1 and SLA2, which define the recessed portion CCP, may correspond to a shape of the slope jig part in the window manufacture device according to an embodiment to be described later. The one surface of each of the slope areas SLA1 and SLA2 may have a shape symmetrical to one surface of the slope jig part.

The recessed portion CCP may be defined to include one surface of the flat area FLA. The flat area FLA may correspond to a portion having one surface which is substantially flat. The one surface of the flat area FLA may extend to be parallel to one surface (e.g., a top surface or a bottom surface) of the non-folding portions NFP1 and NFP2.

In the window WP according to an embodiment, a boundary portion between the flat area FLA and each of the slope areas SLA1 and SLA2 may smoothly continue without a discontinuous portion or a stepped portion so that a top surface of the recessed portion CCP may have a continuous surface. In the window manufactured to have a smoothly continuous surface having no stepped portion, a stepped portion or a processing scar of the surface may not be visible, and thus the window may exhibit improved outer appearance quality. In addition, in the window manufactured such that a stepped portion is not present, a relative decrease in impact resistance at a stepped portion may be improved, and thus the window may exhibit high durability.

The shape of the recessed portion CCP of the window WP illustrated in FIG. 6 is merely an example, and the shape of the recessed portion may be changed according to the folding or bending characteristics desired in the electronic device or the like. In an embodiment, for example, a radius of curvature, a shape of the curved surface, or the like in the slope areas SLA1 and SLA2 each having a curved surface shape may be changed according to the folding or bending characteristics desired in the electronic device. In addition, the slope areas SLA1 and SLA2 may be provided to include inclined surfaces. A width of each of the slope areas SLA1 and SLA2, a width of the flat area FLA, a depth of the flat area FLA, or the like in the recessed portion CCP may be changed according to the folding or bending characteristics desired in the electronic device. In addition, a plurality of recessed portions may be defined, and positions at which the recessed portions are defined may be changed.

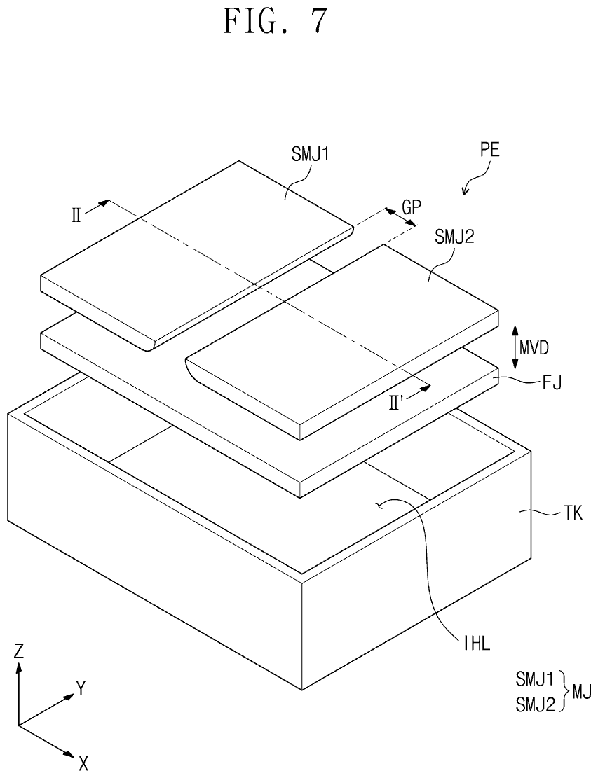

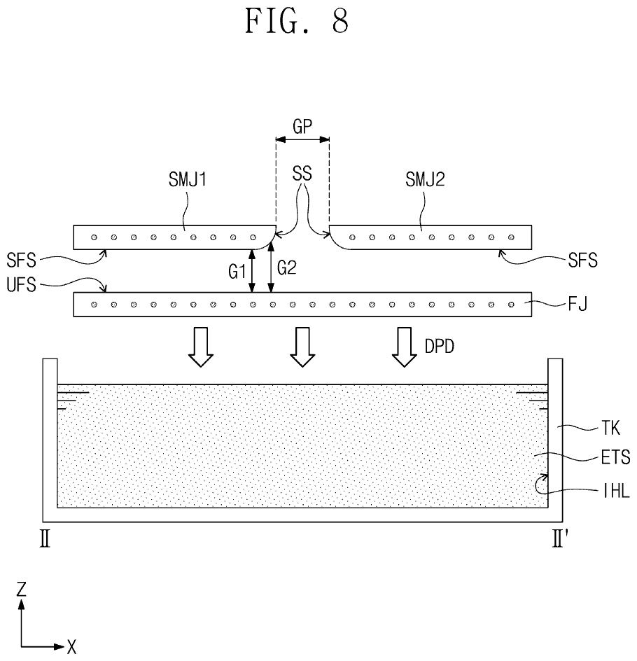

FIG. 7 is a perspective view of a window manufacturing device according to an embodiment. FIG. 8 is a cross-sectional view of a window manufacturing device according to an embodiment. FIG. 8 may be a cross-sectional view corresponding to a cross-section taken along line II-II′ in FIG. 7. A window manufacturing device PE according to an embodiment may include a fixing jig FJ and a masking jig MJ disposed on the fixing jig FJ.

The window manufacturing device PE according to an embodiment may further include an etchant supply part TK. The etchant supply part TK may be an open top tank. The etchant supply part TK may be disposed below the fixing jig FJ. The fixing jig FJ and the masking jig MJ may be completely immersed in the etchant supply part TK during a window manufacturing process. In the window manufacturing device PE according to an embodiment, the fixing jig FJ and the masking jig MJ may be moved in a dipping direction DPD and disposed in an inner space IHL of the etchant supply part TK.

The etchant supply part TK may be a portion where an etchant is supplied or an etchant is stored during the window manufacturing process. As the fixing jig FJ and the masking jig MJ are completely immersed in the inner space IHL of the etchant supply part TK, preliminary glass disposed between the fixing jig FJ and the masking jig MJ may be processed by an etchant ETS.

Among an X axis X, a Y axis Y, and a Z axis Z shown in FIG. 7 and the following drawings, a direction of the Z axis Z is defined as an upward direction. In addition, the X axis X and the Y axis Y may be perpendicular to each other, and the Z axis Z may be a normal direction to a plane defined by the X axis X and the Y axis Y.

The X axis X may correspond to the first direction DR1 illustrated in the foregoing drawings, the Y axis Y may correspond to the second direction DR2 illustrated in the foregoing drawings, and the Z axis may correspond to the third direction DR3 illustrated in the foregoing drawings.

The fixing jig FJ may include a seating surface UFS that is one surface on which a member or object to be processed is disposed. The seating surface UFS may be a flat surface. In the window manufacturing device PE according to an embodiment, the member or object to be processed may be a glass substrate. In the present disclosure, the glass substrate, which is the member or object to be processed before manufactured as a window, may be referred to as preliminary glass.

The masking jig MJ may be disposed on the fixing jig FJ with the preliminary glass disposed between the masking jig MJ and the fixing jig FJ. The fixing jig FJ and the masking jig MJ may be operation-controlled in a movement direction MVD that is an up-down direction, so that the fixing jig FJ and the masking jig MJ are adjacent to or spaced apart from each other. In an embodiment, the operations may be controlled such that each of the seating surface UFS of the fixing jig FJ and a flat surface SFS of the masking jig MJ is fixed to be in close contact with a corresponding (or facing) surface of the preliminary glass.

The preliminary glass, which is covered by the seating surface UFS of the fixing jig FJ and the flat surface SFS of the masking jig MJ, may be protected without being exposed to the etchant ETS. In an embodiment, the fixing jig FJ and the masking jig MJ may include a material having chemical resistance against the etchant ETS. In an embodiment, the etchant ETS may include a hydrofluoric acid solution, and the fixing jig FJ and the masking jig MJ may include an anti-hydrofluoric acid material.

In an embodiment, the masking jig MJ and the fixing jig FJ may each independently include Teflon® (polytetrafluoroethylene) or polyetheretherketone. In an embodiment, for example, the masking jig MJ and the fixing jig FJ of the window manufacturing device PE according to an embodiment may include polyetheretherketone.

The masking jig MJ may include a first sub-mask SMJ1 and a second sub-mask SMJ2 which are spaced from each other by a certain distance GP. One surface of each of the sub-masks SMJ1 and SMJ2, which faces the seating surface UFS of the fixing jig FJ, may include an inclined surface SS.

Each of the first sub-mask SMJ1 and the second sub-mask SMJ2 may include the flat surface SFS, which is flat and faces the seating surface UFS of the fixing jig FJ, and the inclined surface SS having distances G1 and G2 from the seating surface UFS, which gradually increase in a direction that is away from the flat surface SFS.

Referring to FIGS. 7 and 8, in an embodiment, the first sub-mask SMJ1 and the second sub-mask SMJ2 may be spaced from each other by a first distance GP in an X-axis X direction that is one direction. A portion spaced by the first distance GP may correspond to the flat area FLA in the window WP according to an embodiment described with reference to FIG. 6. In an embodiment, for example, a width in the first direction DR1 of the flat area FLA (see FIG. 6) in the window WP according to an embodiment may correspond to the first distance GP by which the first sub-mask SMJ1 and the second sub-mask SMJ2 are spaced from each other in the window manufacturing device PE according to an embodiment.

FIG. 9A is an enlarged cross-sectional view illustrating a portion of a window manufacturing device in an operating state according to an embodiment. FIG. 9B is a schematic view illustrating a masking jig of the window manufacturing device according to an embodiment and a shape of a portion of a window manufactured using the window manufacturing device.

FIG. 9A illustrates only a first sub-mask SMJ1, which is a portion of a masking jig MJ (see FIG. 7), and a portion of a fixing jig FJ facing the first sub-mask SMJ1. However, the same contents about features of the window manufacturing device according to an embodiment described with reference to FIG. 9A may apply to the second sub-mask SMJ2 (see FIG. 8) and the fixing jig FJ facing the second sub-mask SMJ2.

The first sub-mask SMJ1 may include a flat jig part NP and a slope jig part OHP. The flat jig part NP may include a flat surface SFS facing a seating surface UFS of the fixing jig FJ. The slope jig part OHP may include an inclined surface SS extending from the flat surface SFS and having a distance from the seating surface UFS in a thickness direction (Z-axis direction Z), which gradually increases in a direction that is away from the flat surface SFS.

The slope jig part OHP may have an overhang shape on a cross-section defined by the X axis X and the Z axis Z. The slope jig part OHP may have a shape in which a width in the X-axis X direction gradually increases in a thickness direction. Accordingly, a separation space between the slope jig part OHP and preliminary glass P-WP, which is a member or object to be processed, in the Z-axis Z direction may gradually increase in the X-axis X direction that is one direction.

The inclined surface SS of the slope jig part OHP may include an inclined flat surface without a discontinuity, or an inclined curved surface having a shape convex toward the fixing jig FJ. The inclined surface SS of the slope jig part OHP may be spaced apart from the preliminary glass P-WP to expose one surface of the preliminary glass P-WP.

The preliminary glass P-WP disposed between the fixing jig FJ and the sub-mask SMJ1 may include a preliminary folding portion P-FP and a preliminary non-folding portion P-NF. The preliminary folding portion P-FP may include a preliminary flat area P-FA and a preliminary slope area P-SA.

The preliminary folding portion P-FP may be a portion disposed below the slope jig part OHP, and the preliminary non-folding portion P-NF may be a portion disposed below the flat jig part NP. The preliminary folding portion P-FP may be a portion processed as the folding portion FP (see FIG. 6) in the window according to an embodiment described with reference to FIG. 6, and the preliminary non-folding portion and P-NF may be a portion processed as each of the non-folding portions NFP1 and NFP2 (see FIG. 6) in the window according to an embodiment described with reference to FIG. 6.

The preliminary slope area P-SA of the preliminary folding portion P-FP may be processed below the slope jig part OHP, and be formed as each of the slope areas SLA1 and SLA2 (see FIG. 6) in the window according to an embodiment described with reference to FIG. 6. In addition, the preliminary flat area P-FA of the preliminary folding portion P-FP may be processed in an area where the sub-masks are spaced, and be formed as the flat area FLA (see FIG. 6) in the window according to an embodiment described with reference to FIG. 6.

Referring to FIG. 9A, a width WD of the slope jig part OHP in the X-axis X direction may correspond to a width of the preliminary slope area P-SA in the X-axis X direction, and a width of the slope jig part OHP in one direction, which overlaps the preliminary slope area P-SA, may correspond to a width of each of the slope areas SLA1 and SLA2 (see FIG. 6) in the window according to an embodiment described with reference to FIG. 6.

In an embodiment illustrated in FIG. 9A, a difference HT in thickness in the third direction (the Z-axis Z direction) between one end of the slope jig part OHP, which is connected to the flat jig part NP, and the other end (or an opposing end) of the slope jig part OHP, which is spaced apart from the flat jig part NP, may be about 0.7 millimeter (mm) or less.

In an embodiment, in which the sub-mask of the masking jig has a structure having an overhang shape, a gap between the sub-mask and the preliminary glass may be generated due to the overhang shape, and the difference HT in thickness in the second direction (the Z-axis Z direction) between the one end of the slope jig part OHP, which is connected to the flat jig part NP, and the other end (or opposing end) of the slope jig part OHP, which is spaced apart from the flat jig part NP, may correspond to the gap between the sub-mask and the preliminary glass. Thus, in an embodiment, a maximum value of the gap between the sub-mask having the overhang shape and the preliminary glass may be about 0.7 mm or less.

When the maximum value of the gap is greater than about 0.7 mm, an amount of an etchant provided to the preliminary glass P-WP disposed below the slope jig part OHP may be excessively large, and as there is more time for the preliminary glass P-WP to be exposed to the etchant, an etch rate of the preliminary glass exposed at the gap portion is increased. Thus, when the difference HT in thickness in the second direction (the Z-axis Z direction), i.e., the gap, between the one end of the slope jig part OHP, which is connected to the flat jig part NP, and the other end (or an opposing end) of the slope jig part OHP, which is spaced apart from the flat jig part NP, is greater than about 0.7 mm, a stepped portion, which is not gentle, may be generated between a portion, which is disposed below the slope jig part OHP, of the preliminary glass P-WP and a portion, which is not overlapped by the sub-mask SMJ1, of the preliminary glass P-WP. In an embodiment, for example, when the gap between one end of the slope jig part OHP and the preliminary glass P-WP is greater than about 0.7 mm, a groove due to excessive etching may be generated in a portion of the preliminary glass P-WP, which overlaps the one end of the slope jig part OHP.

In an embodiment, the difference HT in thickness in the Z-axis Z direction between the one end of the slope jig part OHP, which is connected to the flat jig part NP, and the other end (or an opposing end) of the slope jig part OHP, which is spaced apart from the flat jig part NP, may be about 10 times to about 30 times a difference HCCP in thickness in the third direction DR3, i.e., a thickness direction, between each of the non-folding portions NFP1 and NFP2 and the flat area FLA in the window WP (see FIG. 6) formed by processing the preliminary glass.

A degree of tilt of the inclined surface SS or a degree of bend of the inclined surface SS of the slope jig part OHP in the window manufacturing device according to an embodiment may be adjusted in light of the depth HCCP (see FIG. 6) of the recessed portion CCP (see FIG. 6) desired in the window according to an embodiment. In an embodiment, the difference HT in thickness in the Z-axis Z direction between the one end of the slope jig part OHP, which is connected to the flat jig part NP, and the other end (or an opposing end) of the slope jig part OHP, which is spaced apart from the flat jig part NP, may be set to be about 10 times to about 30 times the difference HCCP in thickness in the third direction DR3 between each of the non-folding portions NFP1 and NFP2 (see FIG. 6) and the flat area FLA (see FIG. 6) in the window WP (see FIG. 6), thereby exhibiting gentle surface quality without a stepped portion between the flat area FLA and each of the slope areas SLA1 and SLA2 (see FIG. 6).

FIG. 9A illustrates a state in which the preliminary glass P-WP that is a member to be processed is disposed between the masking jig MJ and the fixing jig FJ. The preliminary glass P-WP that is the member to be processed may be processed in a fixed state between the fixing jig FJ and the sub-mask SMJ1 constituting the masking jig MJ. The preliminary glass P-WP may be fixed between the fixing jig FJ and the sub-mask SMJ1 while forming the recessed portion CCP (see FIG. 6) by etching the etchant.

In an embodiment, the fixing jig FJ and the sub-mask SMJ1 may be fixed to face each other by a magnetic force. A magnet may be included inside each of the fixing jig FJ and the sub-mask SMJ1.

The fixing jig FJ and the sub-mask SMJ1 may include base portions LBP and UBP and magnets LMG and UMG, respectively. The base portions LBP and UBP may each include an anti-hydrofluoric acid material having durability against a hydrofluoric acid solution used as etchant. As described above, the base portions LBP and UBP may include Teflon® (polytetrafluoroethylene) or polyetheretherketone.

The magnets LMG and UMG may be disposed in the base portions LBP and UBP. The masking jig MJ (see FIG. 7) and the fixing jig FJ may be fixed to be adjacent to each other by the magnets LMG and UMG with the preliminary glass P-WP disposed between the masking jig MJ and the fixing jig FJ.

FIG. 9B is a view illustrating an example of a shape of a slope jig part and a shape of a slope area of a window, corresponding to the shape of the slope jig part. A shape of one surface US-SLA of a slope area SLA of a window WP manufactured by a window manufacturing device according to an embodiment may be manufactured as a substantially symmetrical shape corresponding to a shape of a slope jig of a masking jig MJ. The shape of the one surface US-SLA of the slope area SLA of the window WP and the shape of a bottom surface SS of the slope jig of the masking jig MJ may be substantially symmetrical with respect to an imaginary reference line RFL.

FIG. 9B illustrates an embodiment in which the inclined surface SS of the masking jig MJ has a curved surface that is convex downward, and the top surface US-SLA of the window WP manufactured to be symmetrical to the inclined surface SS has a curved surface that is convex upward. However, this corresponds to an ideal processed form, and the shape of the inclined surface SS of the masking jig may be adjusted to control the shape of the slope area of the window WP.

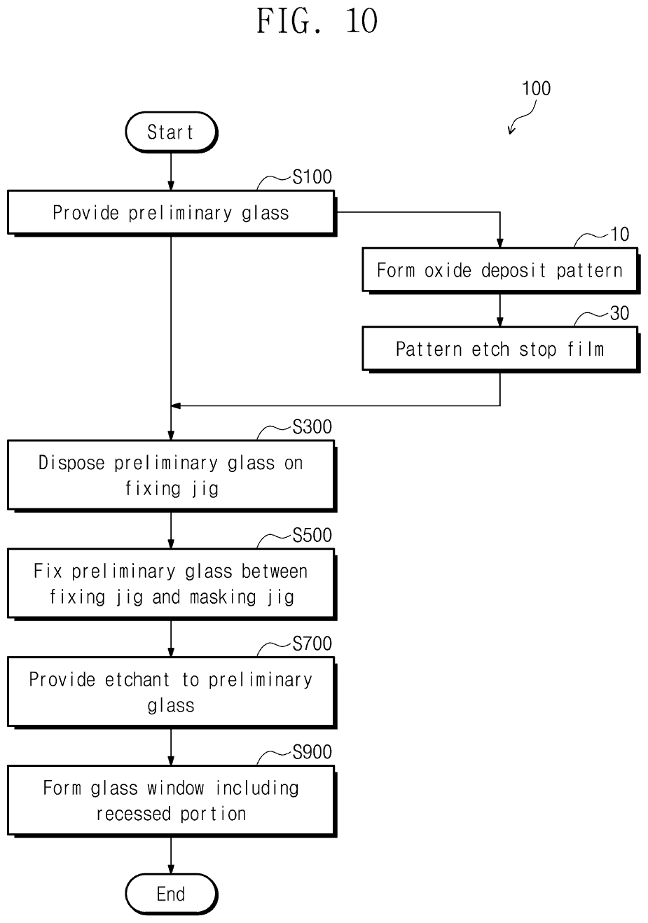

Hereinafter, a window manufacturing method according to an embodiment will be described with reference to FIGS. 10 to 13E. The window manufacturing method according to an embodiment will be described by avoiding any repetitive detailed description of the same or like elements as those described with reference to FIGS. 1 to 9B, and mainly described in terms of differences.

FIG. 10 is a flowchart of a window manufacturing method according to an embodiment.

A window manufacturing method 100 according to an embodiment may include disposing preliminary glass on a fixing jig (S300), fixing the preliminary glass between the fixing jig and a masking jig (S500), providing an etchant to the preliminary glass (S700), and forming a glass window including a recessed portion (S900). The window manufacturing method 100 according to an embodiment may include providing the preliminary glass (S100).

The window manufacturing method 100 according to an embodiment may further include patterning an etch stop film (30) between the providing of the preliminary glass (S100) and the disposing of the preliminary glass on the fixing jig (S300). The window manufacturing method 100 according to an embodiment may further include forming an oxide deposit pattern (10) and the patterning of the etch stop film (30) between the providing of the preliminary glass (S100) and the disposing of the preliminary glass on the fixing jig (S300).

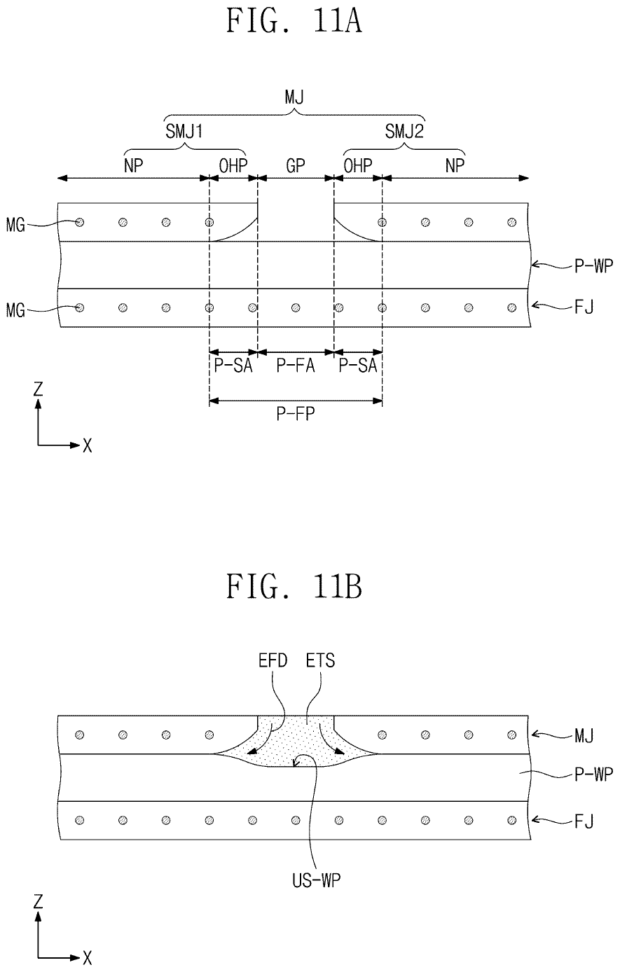

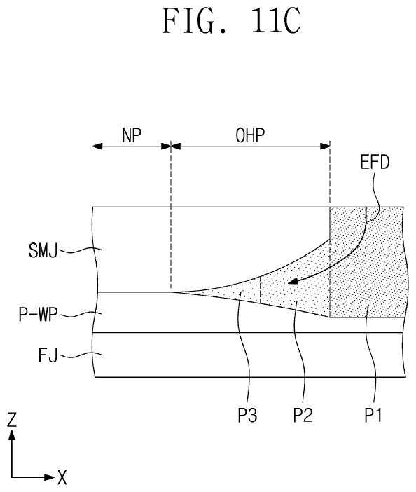

FIG. 11A illustrates an example of the fixing of the preliminary glass between the fixing jig and the masking jig. A first sub-mask SMJ1 and a second sub-mask SMJ2 of the masking jig may be arranged to be spaced from each other by a first distance GP in an X-axis X direction that is one direction.

Preliminary glass P-WP may be fixed between a fixing jig FJ and each of the sub-masks SMJ1 and SMJ2. A preliminary folding portion P-FP of the preliminary glass P-WP may include a preliminary slope area P-SA to be processed to correspond to a slope jig part OHP, and a preliminary flat area P-FA to be processed at a portion corresponding to a separation space between the sub-masks SMJ1 and SMJ2.

The first sub-mask SMJ1 and the second sub-mask SMJ2 of a masking jig MJ may be arranged to be spaced from each other by the first distance. The preliminary glass P-WP may be disposed fixed between the two jigs by a magnetic force of a magnet MG.

FIG. 11B illustrates an example of the providing of the etchant to the preliminary glass. FIG. 11C is an enlarged view illustrating the providing of the etchant.

Referring to FIGS. 11A to 11C, an etchant ETS may be provided to the preliminary glass P-WP through the separation space between the first sub-mask SMJ1 and the second sub-mask SMJ2, which are spaced apart from each other.

The etchant ETS may be permeated and supplied from the separation space between the first sub-mask SMJ1 and the second sub-mask SMJ2 into a separation space between the preliminary glass P-WP and each of the sub-masks SMJ1 and SMJ2. FIG. 11B illustrates an example of a flow direction EFD of the etchant ETS. In an embodiment, the providing of the etchant may be performed by fixing the preliminary glass between the fixing jig and the masking jig and completely immersing, in the etchant, the fixing jig and the masking jig in a state of fixing the preliminary glass. In an embodiment, for example, the fixing jig and the masking jig between which the preliminary glass is disposed may be immersed in the inner space IHL (see FIG. 7) of the etchant supply part TK (see FIG. 7) filled with the etchant.

The etchant ETS may be provided to the preliminary glass P-WP, exposed below the inclination surfaces of the sub-masks, through the separation space or area between the first sub-mask SMJ1 and the second sub-mask SMJ2 of the masking jig. The etchant ETS may be provided to a top surface US-WP of the preliminary glass P-WP, and at least a portion of the top surface US-WP may be etched and removed.

The flow direction EFD of the etchant may be a direction from the separation area between the first sub-mask SMJ1 and the second sub-mask SMJ2 of the masking jig toward a space between the masking jig MJ and the preliminary glass P-WP. Accordingly, the etchant ETS may be provided to a space between the slope jig part OHP and the preliminary glass P-WP through the separation area or space between the first sub-mask SMJ1 and the second sub-mask SMJ2. The exposed top surface US-WP of the preliminary glass P-WP may be sequentially etched according to the flow direction EFD of the etchant.

The etchant ETS may include a hydrofluoric acid solution. In an embodiment, for example, the etchant ETS may include ammonium fluoride (NH₄HF₂) or hydrofluoric acid (HF). The fixing jig and the masking jig in the window manufacturing device according to an embodiment used in the window manufacturing method according to an embodiment may each include an anti-hydrofluoric acid material.

In an embodiment, as shown in FIG. 11C, the etchant ETS may be provided to permeate a space between the slope jig part OHP of a sub-mask SMJ and the preliminary glass P-WP in the flow direction EFD corresponding to the shape of the slope jig part OHP, and accordingly, an amount of the etchant ETS provided to the preliminary glass P-WP disposed below the slope jig part OHP may be different. According to the flow direction EFD of the etchant ETS, the amount of the etchant ETS provided to the preliminary glass P-WP may gradually decrease in a direction from a first point P1 to a third point P3. In addition, in an embodiment, according to the flow direction EFD of the etchant ETS, time for the preliminary glass P-WP to be exposed to the etchant ETS may gradually decrease in the direction from the first point P1 to the third point P3.

A degree at which the preliminary glass P-WP disposed below the slope jig part OHP is exposed to the etchant ETS may be different (or differently set) according to a shape of an overhang structure of the slope jig part OHP, and accordingly, the preliminary glass P-WP may be etched to have a shape having a gentle slope without a stepped portion and a discontinuity in the preliminary slope area P-SA. In addition, a portion of the preliminary glass P-WP disposed below the slope jig part OHP may be a portion continuous with a portion of the preliminary glass P-WP exposed without overlapping the masking jig, and be continuously provided with the etchant ETS so that the entire portion of the preliminary glass P-WP provided with the etchant ETS exhibits improved surface characteristics without a processing scar and a stepped portion.

Accordingly, the window according to an embodiment manufactured by the window manufacturing method according to an embodiment may exhibit high surface quality where there are no discontinuity and processing scar throughout a top surface of the recessed portion that is a processed surface, and may have a gentle inclined surface having no angular portion caused by a stepped portion or the like to exhibit high durability.

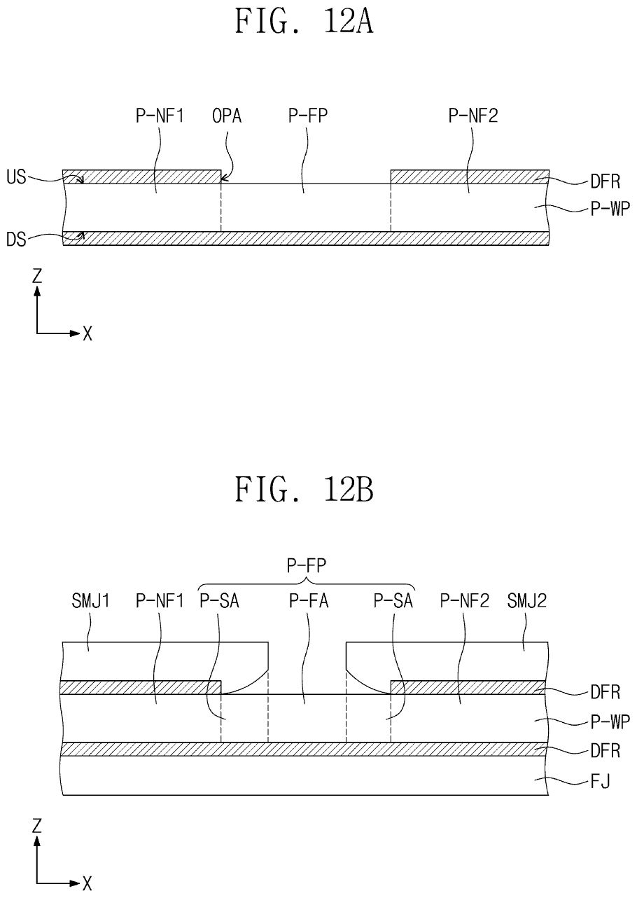

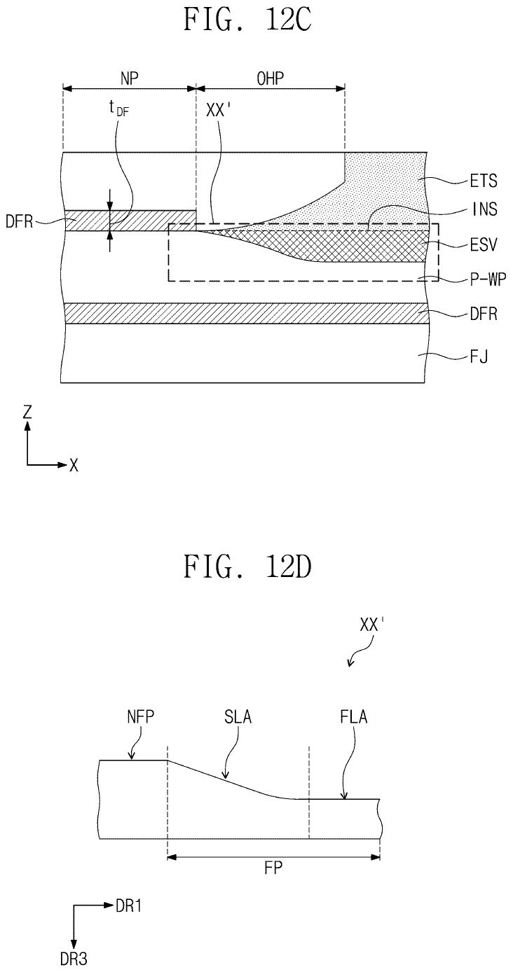

As an example, FIGS. 12A to 12C each illustrate a process of a window manufacturing method according to an embodiment. FIG. 12D is a cross-sectional view illustrating a portion of a window according to an embodiment manufactured by the window manufacturing method according to an embodiment in FIGS. 12A to 12C. FIG. 12D illustrates a portion corresponding to portion XX′ in FIG. 12C.

The window manufacturing method according to an embodiment to be described with reference to FIGS. 12A to 12C is substantially the same as the window manufacturing method according to an embodiment described with reference to FIGS. 11A to 11C except that the window manufacturing method further includes a process of patterning an etch stop film on base glass.

FIG. 12A illustrates an example of the patterning of the etch stop film on preliminary glass. An etch stop film DFR may be disposed on preliminary glass P-WP and protect the preliminary glass P-WP during an etching process. FIG. 12A illustrates the etch stop film DFR being disposed on each of a top surface and a bottom surface of the preliminary glass P-WP, but an embodiment is not limited thereto. In an embodiment, for example, in an embodiment, the etch stop film DFR may be disposed on one surface of the base glass in which the recessed portion CCP (see FIG. 6) is defined.

The etch stop film DFR may have a thickness tDF in a range of about 50 micrometers (μm) to about 300 μm. As the etch stop film DFR is provided in the thickness tDF in a range of about 50 μm to about 300 μm, a portion undesired for etching may be effectively protected even when the preliminary glass P-WP is immersed in an etchant.

The patterning of the etch stop film (30) may be followed by disposing the preliminary glass on a fixing jig (S300), fixing the preliminary glass between the fixing jig and a masking jig (S500), providing an etchant to the preliminary glass (S700), and forming a glass window including a recessed portion (S900).

Referring to FIG. 12A, in the patterning of the etch stop film (30), an open area OPA may be defined in the etch stop film DFR disposed on the top surface of the preliminary glass P-WP. The open area OPA may be defined to overlap a preliminary folding portion P-FP. The etchant may be supplied to the preliminary glass exposed through the open area OPA of the etch stop film DFR formed through the patterning.

FIG. 12B is a view illustrating an example of the disposing of the preliminary glass between the fixing jig and the masking jig. Referring to FIG. 12B, a first sub-mask SMJ1 and a second sub-mask SMJ2 may be arranged to cover a stepped portion of the etch stop film DFR. Referring to FIGS. 12A to 12C, exposed ends of the etch stop film DFR, which define the open area OPA, may be covered by the first sub-mask SMJ1 and the second sub-mask SMJ2, respectively. In an embodiment, for example, each of the exposed ends of the etch stop film DFR, which defines the open area OPA, may be covered by a slope jig part OHP.

Each of the exposed ends of the etch stop film DFR, which defines the open area OPA, may correspond to a boundary between the preliminary folding portion P-FP and each of preliminary non-folding portions P-NF1 and P-NF2. The exposed ends of the etch stop film DFR, which define the open area OPA, may be portions respectively corresponding to the edge portions EDP (see FIG. 6) which are boundaries between the slope areas SLA1 and SLA2 (see FIG. 6) of the folding portion and the non-folding portions NFP1 and NFP2 (see FIG. 6) in the window according to an embodiment illustrated in FIG. 6.

In the window manufacturing method according to an embodiment in which, after the patterning of the etch stop film (30), the disposing of the preliminary glass on the fixing jig (S300), the fixing of the preliminary glass between the fixing jig and the masking jig (S500), the providing the etchant to the preliminary glass (S700), and the forming of the glass window including the recessed portion (S900) are perform, an etchant ETS may be provided onto the preliminary glass P-WP which is exposed as not being covered by the etch stop film DFR. The etchant ETS may be provided to a space between the slope jig part OHP and the preliminary glass P-WP, and an etch amount ESV of the preliminary glass P-WP may be different according to an overhang shape of the slope jig part OHP. The etch amount ESV of the preliminary glass may be compared on the basis of an initial state INS of the preliminary glass P-WP before etching. Due to the shape feature of the slope jig part OHP, the etch amount ESV of the preliminary glass may gradually decrease in a direction from the slope jig part OHP toward a flat jig part NP.

The etch stop film DFR may be removed after the providing of the etchant to the preliminary glass (S700) and the forming of the glass window including the recessed portion (S900).

FIG. 12D illustrates an embodiment of a window manufactured by the window manufacturing method according to an embodiment described with reference to FIGS. 12A to 12C.

Referring to FIG. 12D, the window according to an embodiment may include a folding portion FP and a non-folding portion NFP, and the folding portion FP may be manufactured to include a slope area SLA and a flat area FLA. In the window according to an embodiment manufactured by the window manufacturing method according to an embodiment, according to the shape feature of the slope jig part OHP, the slope area SLA may have a shape having a thickness which gradually increases in a direction from the flat area FLA to the non-folding portion NFP. The slope area SLA may include a top surface which is a gentle curved surface without a stepped portion and a discontinuity. In addition, the window according to an embodiment may exhibit top surface characteristics where there are no stepped portion and discontinuity even at a boundary between the flat area FLA and the slope area SLA. The excellent surface characteristics where there are no processing scar, stepped portion, and the like, throughout the folding portion FP processed with the etchant, may be exhibited.

Accordingly, the window according to an embodiment manufactured by the window manufacturing method according to an embodiment may exhibit excellent surface quality where there are no discontinuity and processing scar throughout a top surface of the recessed portion that is a processed surface, and may have a gentle inclined surface having no angular portion caused by a stepped portion or the like to exhibit excellent durability.

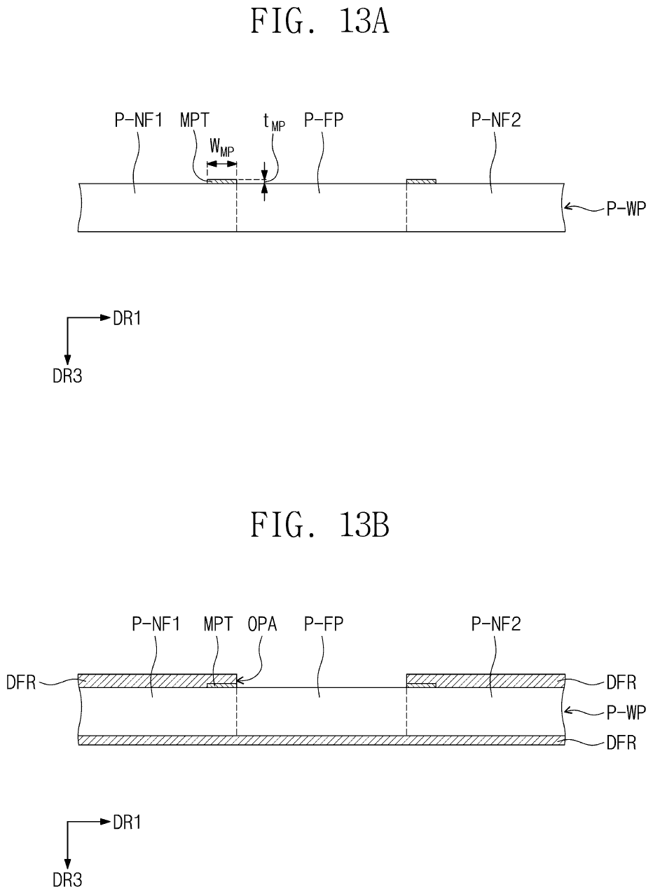

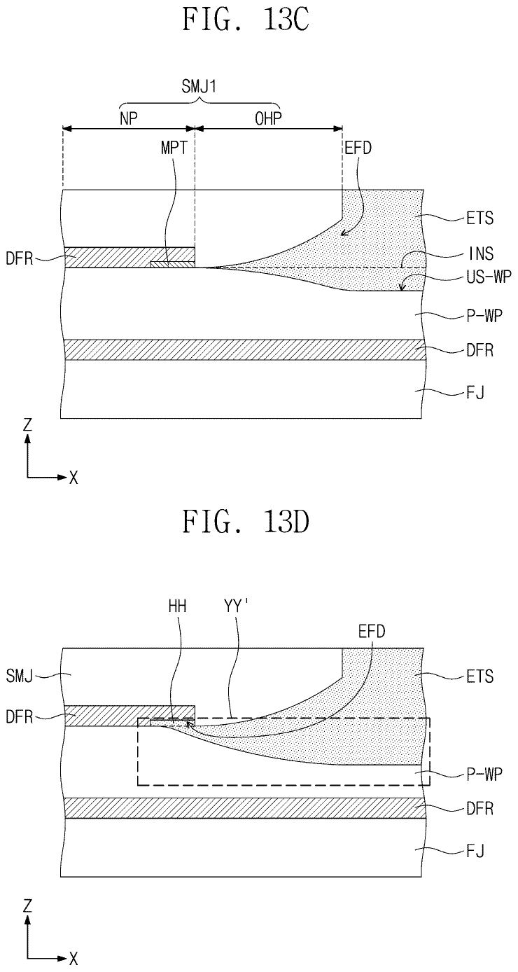

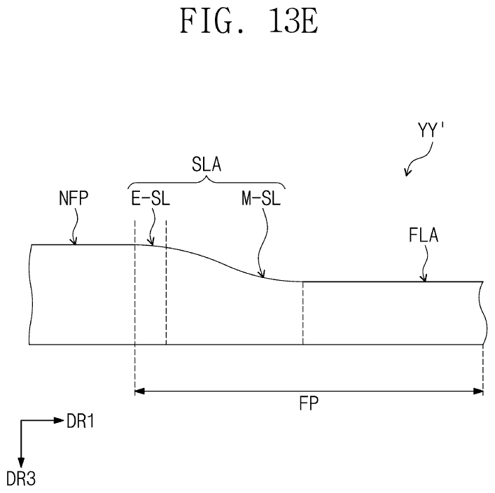

As an example, FIGS. 13A to 13D each illustrate a process of a window manufacturing method according to an embodiment. FIG. 13E is a cross-sectional view illustrating a portion of a window according to an embodiment manufactured by the window manufacturing method according to an embodiment in FIGS. 13A to 13D. FIG. 13E illustrates a portion corresponding to portion YY′ in FIG. 13D.

The window manufacturing method according to an embodiment to be described with reference to FIGS. 13A to 13D is substantially the same as the window manufacturing method according to an embodiment described with reference to FIGS. 11A to 11C except that the window manufacturing method further includes processes of forming an oxide deposit pattern on preliminary glass, and patterning an etch stop film, in which an open area is defined, on the preliminary glass.

FIG. 13A illustrates an example of the forming of the oxide deposit pattern. An oxide deposit pattern MPT may be formed on preliminary glass P-WP. The oxide deposit pattern MPT may be disposed at a boundary portion between a preliminary folding portion P-FP and each of preliminary non-folding portions P-NF1 and P-NF2. For example, in an embodiment, the oxide deposit patterns MPT may be disposed on the preliminary non-folding portions P-NF1 and P-NF2. The oxide deposit pattern MPT may be etched and disposed on only one surface of the preliminary glass P-WP in which the recessed portion CCP (see FIG. 6) is formed. Due to the oxide deposit pattern MPT, a boundary portion between the folding portion and the non-folding portion in the finally manufactured window may smoothly continue as not being angular.

An inorganic oxide may be deposited to form the oxide deposit pattern MPT. In an embodiment, for example, the oxide deposit pattern MPT may include an indium oxide. The oxide deposit pattern MPT may have a thickness tMP of about 10 μm or less. When the thickness tMP of the oxide deposit pattern MPT is greater than about 10 μm, the boundary portion between the preliminary folding portion P-FP and each of the preliminary non-folding portions P-NF1 and P-NF2 may not be gently etched.

In addition, the oxide deposit pattern MPT may have a width WMP in a range of about 1000 μm to about 2000 μm in the first direction DR1. When the width WMP of the oxide deposit pattern MPT in the first direction DR1 is less than about 1000 μm, adhesion of the oxide deposit pattern MPT to the preliminary glass P-WP may be decreased, and when the width WMP of the oxide deposit pattern MPT in the first direction DR1 is greater than about 2000 μm, a surface area of the boundary portion between the preliminary folding portion P-FP and each of the preliminary non-folding portions P-NF1 and P-NF2 may be increased.

FIG. 13B is a view illustrating an example of the patterning of the etch stop film. An etch stop film DFR may be disposed on the preliminary glass P-WP and protect the preliminary glass P-WP during an etching process.

The patterning of the etch stop film DFR may be a step of patterning the etch stop film DFR while defining an opening area OPA on the preliminary glass P-WP to cover the oxide deposit pattern MPT but expose one side surface of the oxide deposit pattern MPT. One side surface of the oxide deposit pattern MPT and one side surface of the etch stop film DFR may be patterned to overlap each other. The one side surface of the oxide deposit pattern MPT and the one side surface of the etch stop film DFR, which overlap each other, may define the opening area OPA.

FIG. 13B illustrates the etch stop film DFR being disposed on each of a top surface and a bottom surface of the preliminary glass P-WP, but an embodiment is not limited thereto. For example, in an embodiment, the etch stop film DFR may be disposed on only one surface of base glass in which the recessed portion CCP (see FIG. 6) is defined.

The same/similar contents as/to the contents described with reference to FIG. 12A may apply to the etch stop film DFR illustrated in FIG. 13B, except that the etch stop film DFR is arranged to cover a portion of the oxide deposit pattern MPT.

The patterning of the etch stop film (30) may be followed by disposing the preliminary glass on a fixing jig (S300), fixing the preliminary glass between the fixing jig and a masking jig (S500), providing an etchant to the preliminary glass (S700), and forming a glass window including a recessed portion (S900).

FIGS. 13C and 13D each illustrate an example of the providing of the etchant to the preliminary glass (S700). An etchant ETS may be provided on one exposed surface of the preliminary glass P-WP fixed between a fixing jig FJ and a masking jig MJ. The same/similar contents as/to the contents described with reference to FIGS. 11B and 11C may apply to the providing of the etchant.

Referring to FIGS. 13A to 13D, each of exposed ends of the etch stop film DFR and the oxide deposit pattern MPT, which defines the open area OPA, may correspond to a boundary between the preliminary folding portion P-FP and each of the preliminary non-folding portions P-NF1 and P-NF2. The exposed ends of the etch stop film DFR and the oxide deposit pattern MPT, which define the open area OPA, may be portions respectively corresponding to the edge portions EDP (see FIG. 6) which are boundaries between the slope areas SLA1 and SLA2 (see FIG. 6) of the folding portion and the non-folding portions NFP1 and NFP2 (see FIG. 6) in the window according to an embodiment illustrated in FIG. 6.

In the window manufacturing method according to an embodiment, the etchant ETS may be provided onto the preliminary glass P-WP which is exposed as not being covered by the etch stop film DFR or the oxide deposit pattern MPT. The etchant ETS may be provided to a space between the slope jig part OHP and the preliminary glass P-WP, and an etch amount of the preliminary glass P-WP may be different according to an overhang shape of the slope jig part OHP. As the etching of the preliminary glass P-WP progresses, one surface in an initial state INS of the preliminary glass P-WP may be gradually shifted in a thickness direction to form a top surface US-WP of the window which defines the recessed portion CCP (see FIG. 6). Due to the shape feature of the slope jig part OHP, the etch amount of the preliminary glass P-WP may gradually decrease in a direction from the slope jig part OHP toward a flat jig part NP.

Referring to FIGS. 13C and 13D, a flow direction EFD of the etchant ETS may be toward the oxide deposit pattern MPT. The etchant ETS may be provided to the oxide deposit pattern MPT, and the oxide deposit pattern MPT may be removed by the etchant ETS. That is, in the window manufacturing method according to an embodiment, the etchant ETS may be provided up to the oxide deposit pattern MPT in the providing of the etchant to the preliminary glass (S700). In addition, the oxide deposit pattern MPT may be removed in the forming of the glass window including the recessed portion (S900).

The etchant ETS may be provided to a portion in which the oxide deposit pattern MPT is formed, and gradually remove the oxide deposit pattern MPT. Accordingly, a groove space HH may be defined in a lower portion of the etch stop film DFR in which the oxide deposit pattern MPT was disposed. The etchant ETS may be delivered into the groove space HH. Accordingly, the preliminary glass P-WP disposed below the groove space HH may be additionally etched.

FIG. 13E illustrates an embodiment of a window manufactured by the window manufacturing method according to an embodiment described with reference to FIGS. 13A to 13D.

Referring to FIG. 13E, the window according to an embodiment may include a folding portion FP and a non-folding portion NFP, and the folding portion FP may be manufactured to include a slope area SLA and a flat area FLA. In addition, compared to the window according to an embodiment described with reference to FIG. 12D, the slope area SLA may be divided into a main slope area M-SL and an edge slope area E-SL.

The window according to an embodiment manufactured by the window manufacturing method according to an embodiment described with reference to FIGS. 13A to 13D may further include the edge slope area E-SL.

In the window according to an embodiment, according to the shape feature of the slope jig part OHP, the slope area SLA may have a shape having a thickness which gradually increases in a direction from the flat area FLA to the non-folding portion NFP. The slope area SLA may include a top surface which is a gentle curved surface without a stepped portion and a discontinuity. The window according to an embodiment may exhibit top surface characteristics without a stepped portion and a discontinuity even at a boundary between the flat area FLA and the slope area SLA.

In addition, the window according to an embodiment may include the edge slope area E-SL corresponding to an additional portion which is gradually etched by the oxide deposit pattern MPT, thereby having a bending surface in which a boundary portion between the folding portion FP and the non-folding portion NFP smoothly continues.

Thus, the window according to an embodiment manufactured by the window manufacturing method according to an embodiment described with reference to FIGS. 13A to 13D may exhibit improved surface characteristics where there are no processing scar, stepped portion, and the like throughout the folding portion FP processed with the etchant, and have a shape of a smooth curved surface having no angular portion even at the boundary portion between the folding portion FP and the non-folding portion NFP. Accordingly, the window according to an embodiment manufactured by the window manufacturing method according to an embodiment may exhibit high surface quality where there are no discontinuity and processing scar throughout a top surface of the recessed portion that is a processed surface, and may have a gentle inclined surface having no angular portion to improve impact resistance of the window for the angular portion, thereby exhibiting high durability.

A window manufacturing device according to an embodiment may include a fixing jig, and a masking jig including sub-masks in which a surface facing the fixing jig has an inclined surface, and the sub-masks may each include a slope jig part having an overhang shape. Accordingly, the window manufacturing device may be used for manufacturing a window having improved surface characteristics without a stepped portion at a slope area and a flat area.

A window manufacturing method according to an embodiment is a window manufacturing method using the window manufacturing device including the sub-mask including the slope jig part having the overhang shape, and may include providing an etchant to preliminary glass disposed below the slope jig part having the overhang shape, thereby manufacturing a window having high surface quality where there are no discontinuity and processing scar throughout a top surface of the recessed portion that is a processed surface. Accordingly, the window manufactured by the window manufacturing method according to an embodiment may have a gentle inclined surface having no angular portion to exhibit high durability.

The window manufacturing device according to the embodiment may include the masking jig including the slope jig part having the overhang shape, thereby manufacturing the window having the improved processing characteristics and surface quality in the slope area of the recessed portion.

The window manufacturing method according to the embodiment may include the forming of the recessed portion in the preliminary glass to manufacture the window by using the window manufacturing device including the mask jig having the overhang shape at the portion corresponding to the slope area, thereby manufacturing the window having the shape of the gentle slope area and the improved surface characteristics.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A window manufacturing device comprising:
a fixing jig comprising a seating surface on which preliminary glass is disposed; and
a masking jig disposed on the fixing jig and comprising a first sub-mask and a second sub-mask which are spaced apart from each other in a first direction,
wherein each of the first sub-mask and the second sub-mask comprises:
a flat jig part having a flat surface facing the seating surface; and
a slope jig part having an inclined surface which extends from the flat surface and has a distance from the seating surface in a thickness direction, wherein the distance gradually increases in a direction away from the flat surface.

2. The window manufacturing device of claim 1, wherein the inclined surface of the slope jig part is an inclined flat surface without a discontinuity, or an inclined curved surface having a shape convex toward the fixing jig.

3. The window manufacturing device of claim 1, wherein the preliminary glass comprises a preliminary folding portion disposed below the slope jig part, and a preliminary non-folding portion disposed below the flat jig part,
wherein the preliminary folding portion is processed to comprise a flat area, and a first slope area and a second slope area which are arranged to be spaced apart from each other in the first direction with the flat area disposed between the first and second slope areas,
wherein a width of the slope jig part in the first direction in each of the first sub-mask and the second sub-mask corresponds to a width of each of the first slope area and the second slope area in the first direction in a folding portion provided by slimming the preliminary glass.

4. The window manufacturing device of claim 3, wherein the folding portion comprises a flat area disposed between the first slope area and the second slope area,
wherein a separation distance between the first sub-mask and the second sub-mask in the first direction corresponds to a width of the flat area in the first direction.

5. The window manufacturing device of claim 3, wherein a difference in thickness in a second direction between one end of the slope jig part, which is connected to the flat jig part, and an opposing end of the slope jig part, which is spaced apart from the flat jig part, is about 0.7 mm or less,
wherein the second direction is perpendicular to the first direction.

6. The window manufacturing device of claim 3, wherein the preliminary non-folding portion below the flat jig part is processed into a non-folding portion,
wherein a difference in thickness in a second direction between one end of the slope jig part, which is connected to the flat jig part, and an opposing end of the slope jig part, which is spaced apart from the flat jig part, is about 10 times to about 30 times a difference in thickness in the second direction between the non-folding portion and the flat area,
wherein the second direction is perpendicular to the first direction.

7. The window manufacturing device of claim 1, wherein the masking jig and the fixing jig each independently comprise polytetrafluoroethylene or polyetheretherketone.

8. The window manufacturing device of claim 1, wherein each of the masking jig and the fixing jig comprises a base portion comprising an anti-hydrofluoric acid material, and a magnet disposed in the base portion,
wherein the masking jig and the fixing jig are fixed to be adjacent to each other by the magnet with the preliminary glass disposed between the masking jig and the fixing jig.

9. The window manufacturing device of claim 1, further comprising an etchant supply part which stores an etchant, in which the fixing jig and the masking jig are immersed.

10. A window manufacturing method using a window manufacturing device comprising a fixing jig, and a masking jig facing the fixing jig and comprising a first sub-mask and a second sub-mask between which a separation area is disposed and each of which comprises a flat surface and an inclined surface having a distance from the fixing jig in a thickness direction, wherein the distance gradually increases in a direction away from the flat surface, the window manufacturing method comprising:
disposing preliminary glass on the fixing jig;
moving the masking jig to fix the preliminary glass between the fixing jig and the masking jig;
providing an etchant to the preliminary glass exposed in the separation area and below the inclined surface; and
etching the preliminary glass to form a glass window comprising a recessed portion defined by a flat area corresponding to the separation area and a slope area corresponding to the inclined surface.

11. The window manufacturing method of claim 10, wherein the etchant comprises a hydrofluoric acid solution, and
each of the fixing jig and the masking jig comprises an anti-hydrofluoric acid material.

12. The window manufacturing method of claim 10, wherein the inclined surface of the masking jig is an inclined flat surface without a discontinuity, or an inclined curved surface having a shape convex toward the fixing jig,
wherein, in the forming of the glass window, one exposed surface of the slope area is formed to have a shape corresponding to the inclined surface.

13. The window manufacturing method of claim 10, wherein the preliminary glass comprises a preliminary folding portion, and a first preliminary non-folding portion and a second preliminary non-folding portion which are spaced apart from each other in a first direction with the preliminary folding portion disposed between the first and second preliminary non-folding portions,
wherein the fixing of the preliminary glass comprises:
totally covering a top surface and a bottom surface of each of the first preliminary non-folding portion and the second preliminary non-folding portion by the fixing jig and the masking jig, and
exposing a partial area of the preliminary folding portion to fix the preliminary glass in a way such that a distance between the inclined surface and the preliminary folding portion gradually increases in a direction from the flat surface to the separation area.

14. The window manufacturing method of claim 13, wherein, in the providing the etchant to the preliminary glass, an amount of the etchant provided to the preliminary glass gradually decreases in a direction from the separation area to the flat surface.

15. The window manufacturing method of claim 10, further comprising, before the disposing the preliminary glass, patterning an etch stop film, in which an open area is defined, on the preliminary glass.

16. The window manufacturing method of claim 15, wherein the open area defines a preliminary folding portion in the preliminary glass, and
in the disposing the preliminary glass, exposed ends of the etch stop film, which define the open area, are covered by the first sub-mask and the second sub-mask, respectively.

17. The window manufacturing method of claim 10, further comprising, before the disposing the preliminary glass:
forming an oxide deposit pattern on the preliminary glass; and
patterning an etch stop film, in which an open area is defined, on the preliminary glass to cover the oxide deposit pattern while exposing one side surface of the oxide deposit pattern.

18. The window manufacturing method of claim 17, wherein the oxide deposit pattern comprises an indium oxide.

19. The window manufacturing method of claim 17, wherein, in the providing the etchant, the etchant is provided to the oxide deposit pattern.

20. The window manufacturing method of claim 17, wherein the preliminary glass comprises a preliminary folding portion, and a first preliminary non-folding portion and a second preliminary non-folding portion which are spaced apart from each other in a first direction with the preliminary folding portion disposed between the first and second preliminary non-folding portions,
wherein, in the forming the oxide deposit pattern, the oxide deposit pattern is formed on each of the first preliminary non-folding portion and the second preliminary non-folding portion,
wherein the oxide deposit pattern has a thickness of about 10 μm or less and has a width in a range of about 1000 μm to about 2000 μm in the first direction.
